(19) United States
(12) Patent Application Publication
(10) Pub. No.: US 2013/0301080 A1
(43) Pub. Date: Nov. 14, 2013

(54) PRINT SYSTEM, PRINT RELAY SERVER, AND CLIENT DEVICE

(71) Applicant: CANON KABUSHIKI KAISHA, Tokyo (JP)

(72) Inventor: Hiroaki Nakata, Kawasaki-shi (JP)

(21) Appl. No.: 13/864,995

(22) Filed: Apr. 17, 2013

(30) Foreign Application Priority Data
Apr. 20, 2012 (JP) 2012-096561
Dec. 28, 2012 (JP) 2012-287238

(51) Int. Cl. G06F 3/12

(52) U.S. Cl. CPC G06F 3/1293
USPC 358/1.15

(57) ABSTRACT

A print relay server receives print data based on content, identification information of a service printer selected via a selection screen for selecting a service printer, and print setting designated via a print setting screen for designating print setting from a print service, and transfers the print data to an image formation apparatus designated as an output destination in the print setting when the received identification information of the service printer indicates a general-purpose service printer.

### BACKGROUND OF THE INVENTION

1. Field of the Invention

Aspects of the present invention generally relate to a print system, a print relay server, and a client device.

2. Description of the Related Art

Previously, there has been a content print system in which a print instruction is transmitted from a client to a server, and the server that has received the print instruction converts content of a print target into print data. In recent years, a concept of cloud computing has drawn attention. This concept can be considered as one form of providing a service to a client from a server, similar to the above-described system. A main feature of cloud computing is that data conversion and data processing are executed in a distributed manner using a lot of computing resources, and requests from a lot of clients are simultaneously processed.

For example, Google™ has developed a data communication mechanism for providing a service in cooperation with an image formation apparatus, and has made available to the public a cloud computing environment and an interface prepared by Google for the image formation apparatus that performs data communication. By implementing the interface into the image formation apparatus, even if the image formation apparatus and a server are connected via the internet, a client can designate and cause the image formation apparatus to perform printing.

Here, Japanese Patent Application Laid-Open No. 2003-196054 discloses a method wherein, in a service in which a server generates print data, the server receives a print instruction and information for controlling printing from a client, and generates the print data based on the information for controlling printing. With this method, printing appropriate for an image formation apparatus can be performed without installing a printer driver to the client.

However, there is difficulty implementing the above described approach with existing image formation apparatuses because they cannot be connected due to the need for a dedicated interface.

Further, it has not been considered how a user designates an output destination of print data.

### SUMMARY OF THE INVENTION

A print system according to an embodiment of the present invention includes a print server and a print relay server that connects a plurality of image information apparatuses and the print server, the print server including a providing unit that provides a selection screen for selecting a printer object and a print setting screen for designating print setting in response to a print instruction of content, a reception unit that receives selection of the printer object and designation of the print setting via the selection screen and the print setting screen, and a transmitting unit that transmits print data based on the content, and identification information of the printer object and the print setting received by the reception unit to the print relay server, and the print relay server including a receiving unit that receives the print data, the identification information of the printer object, and the print setting transmitted from the transmitting unit, and a transferring unit that transfers the print data to an image formation apparatus designated as an output destination in the print setting received by the receiving unit when the identification information of the printer objet received by the receiving unit indicates a general-purpose printer object.

Further features of the present invention will become apparent from the following description of exemplary embodiments (with reference to the attached drawings).

### BRIEF DESCRIPTION OF THE DRAWINGS

FIG. 1 is a diagram illustrating a configuration of a content print system;

FIG. 2 is a hardware block diagram of devices and server groups that configure the content print system;

FIG. 3 is a software block diagram of the devices and the server groups that configure the content print system;

FIG. 4 is a block diagram of a print controller;

FIG. 5 is a block diagram of a relay virtual printer management service;

FIG. 6 is a block diagram of a relay virtual printer;

FIG. 7 is a block diagram of a main processing management service;

FIG. 8 is a block diagram of a cooperation processing management service;

FIG. 9 is a block diagram of a print service proxy;

FIG. 10 is a block diagram of a print service;

FIG. 11A is a diagram illustrating a printer registration UI, FIG. 11B is a diagram illustrating user information UI, FIG. 11C is a diagram illustrating a print setting UI, FIG. 11D is a diagram illustrating a printer addition/deletion UI, and FIG. 11E is a diagram illustrating a UI for selecting a printer of an output destination;

FIG. 12A is a diagram illustrating information stored in a printer information storage unit, FIG. 12B is a diagram illustrating information stored in a user information storage unit, FIG. 12C is a diagram illustrating information stored in a user information storage unit, FIG. 12D is a diagram illustrating information stored in a printer information storage unit, FIG. 12E is a diagram illustrating information stored in a printer information storage unit, FIG. 12B1 is a diagram illustrating information stored in a user information storage unit in a developing embodiment, FIG. 12C1 is a diagram illustrating information stored in a user information storage unit in the developing embodiment, FIG. 12D1 is a diagram illustrating an initial state of information stored in a printer information storage unit in the developing embodiment, FIG. 12D2 is a diagram illustrating information stored in the printer information storage unit after a “Printer 1” is registered in the developing embodiment, FIG. 12D3 is a diagram illustrating information including a print frequency stored in the printer information storage unit in the developing embodiment, FIG. 12E1 is a diagram illustrating an initial state of information stored in a printer information storage unit in the developing embodiment, and FIG. 12E2 is a diagram illustrating information stored in the printer information storage unit after the “Printer 1” is registered in the developing embodiment;

FIG. 13A is a diagram illustrating capabilities expressed in an XML format, FIG. 13B is a diagram illustrating a print setting initial value expressed in an XML format, FIG. 13C is a diagram illustrating print setting expressed in an XML format, FIG. 13D is a diagram illustrating a printer registration request expressed in an XML format, FIG. 13E is a diagram illustrating a reply to the printer registration request expressed in an XML format, FIG. 13F is a diagram illustrating notification information A expressed in an XML format, FIG. 13G is a diagram illustrating notification information B expressed in an XML format, FIG. 13A1 is a diagram illustrating capabilities expressed in an XML format in the developing embodiment, FIG. 13B1 is a diagram illustrating a print setting initial value expressed in an XML format in the developing embodiment, and FIG. 13C1 is a diagram illustrating print setting expressed in an XML format in the developing embodiment;

FIG. 14A is a diagram illustrating capabilities expressed in a JSON format, FIG. 14B is a diagram illustrating a print setting initial value expressed in a JSON format, FIG. 14C is a diagram illustrating print setting expressed in a JSON format, FIG. 14D is a diagram illustrating a printer registration request expressed in a JSON format, FIG. 14E is a diagram illustrating a reply to the printer registration request expressed in a JSON format, FIG. 14F is a diagram illustrating notification information A expressed in a JSON format, FIG. 14G is a diagram illustrating notification information B expressed in a JSON format, FIG. 14A1 is a diagram illustrating capabilities expressed in a JSON format in the developing embodiment, FIG. 14B1 is a diagram illustrating a print setting initial value expressed in a JSON format in the developing embodiment, and 14C1 is a diagram illustrating print setting expressed in a JSON format in the developing embodiment;

FIG. 15 is a diagram illustrating a print button being pressed;

FIG. 16 is a sequence diagram illustrating pre-registration processing of registering a printer to a print relay server;

FIG. 17 is a sequence diagram illustrating main registration of registering the relay virtual printer to the print service;

FIG. 18 (FIG. 18A-18B) shows a sequence diagram illustrating printing series processing for causing the printer to print data transmitted from the print server group;

FIG. 19A is a diagram illustrating a UI that selects a printer of an output destination in the developing embodiment, FIG. 19B is a diagram illustrating a UI that selects a printer of an output destination after a “Printer-1” is automatically registered, FIG. 19C is a diagram illustrating a UI that indicates a print setting screen in the developing embodiment, FIG. 19D is a diagram illustrating display where a printer of an output destination is filtered, and FIG. 19E is a diagram illustrating a UI that indicates a print setting screen;

FIG. 20 (FIG. 20A-20B) shows a sequence diagram illustrating print processing in the developing embodiment;

FIG. 21 is a sequence diagram illustrating automatic registration processing of a dedicated service printer;

FIG. 22 is a flowchart of VPID acquisition processing performed by a print service proxy; and

FIG. 23 is a sequence diagram of registration processing of printer capability information.

### DESCRIPTION OF THE EMBODIMENTS

### Embodiment 1

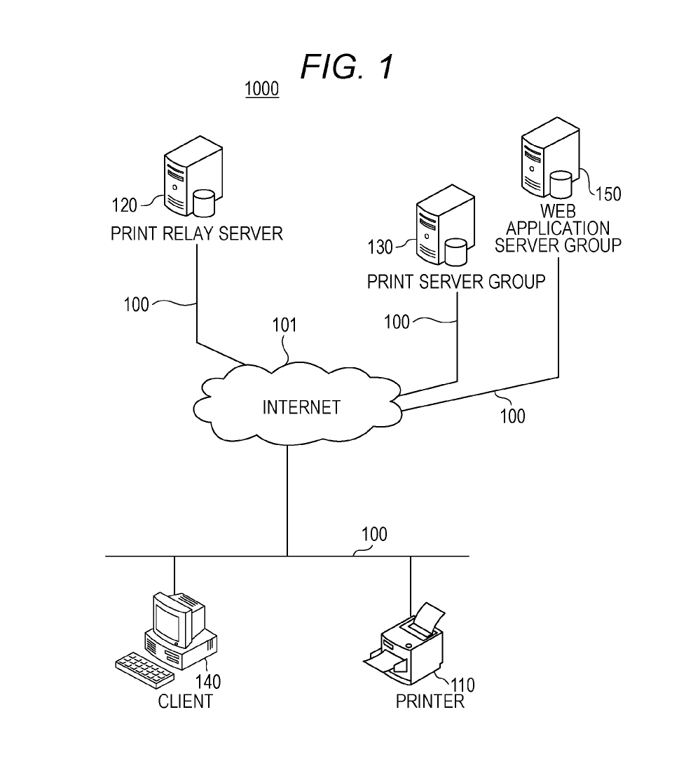

First, a device configuration of a content print system 1000 according to Embodiment 1 will be described. FIG. 1 is a diagram illustrating a device configuration of the content print system 1000. The content print system 1000 includes a client 140 (client device) and a printer 110 (image formation apparatus). The device and the apparatus are arranged in a user environment, and are connected with each other via a network 100, and the network 100 is connected to the Internet 101. Further, the content print system 1000 includes a Web application server group 150 and a print server group 130. The two server groups may be provided by the same vender. In that case, the both server groups may be connected with each other via the network 100. Further, the content print system 1000 includes a print relay server 120. The print relay server 120 is connected to the network 100, and the network 100 is connected to the Internet 101. The device, the apparatus, and the server groups that configure the content print system 1000 can be connected with each other via the Internet 101, and can communicate data with each other. Note that, although the device and the apparatus are one each, a plurality of devices and apparatuses may be employed. Also, although each of the server groups is configured from a plurality of servers, one server may configure each of the server groups.

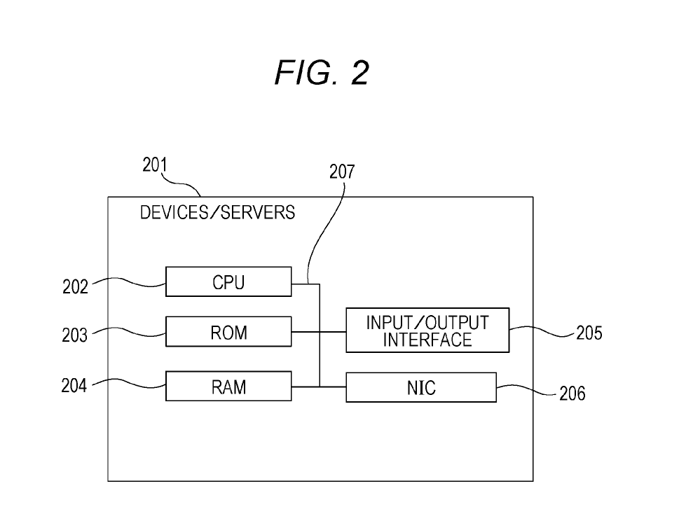

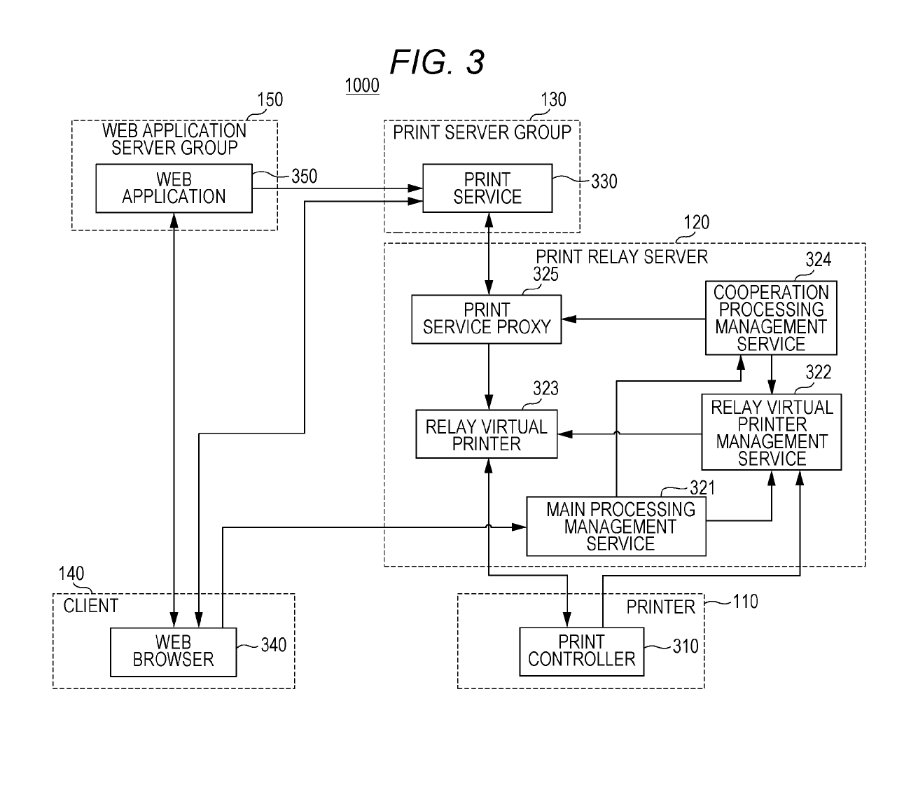

Next, a hardware configuration of devices and server groups that configure the content print system 1000 will be described. FIG. 2 is a diagram illustrating a hardware configuration of a computer that realizes the devices and the server groups that configure the content print system 1000. Devices and servers 201 configure the content print system 1000. A central processing unit (CPU) 202 is a unit to execute various types of programs and realizes various functions. A read only memory (ROM) 203 is a unit to store various types of programs. A random access memory (RAM) 204 is a unit, into which a program stored in the ROM 203 is loaded and the program is executed by the CPU 202. Further, the RAM 204 is a unit used as a temporary work storage area of the CPU 202. An input/output interface 205 is an interface unit to transmit data to a display (not illustrated) connected to the devices and servers as well as receiving data from a pointing device (not illustrated). A network interface card (NIC) 206 is a unit for connecting the devices and the servers that configure the content print system 1000 to the network 100. The units described above are capable of transmitting/receiving data via a bus 207. Further, the printer 110 includes a print unit (not illustrated), and the print unit is capable of transmitting/receiving data to/from each of the units via the bus 207. Note that the print unit is a unit capable of printing a raster image to a storage medium.

Next, a software configuration of each of the devices and the servers that configure the content print system 1000 will be described. FIG. 3 illustrates a software configuration of each of the devices and the servers that configure the content print system 1000. A program illustrated in FIG. 3, which realizes a function of each software configuration, is stored in the ROM 203 of each of the devices and the servers, and the CPU 202 loads the program into the RAM 204 and executes the program, so that the function is realized.

Hereinafter, specific embodiments realized by the devices and the servers will be described. The embodiments will be roughly divided into two parts of a first half and a latter half, and description will be given.

First, in the first half, a basic embodiment including three types of processing included in the devices and the servers will be described.

Next, in the latter half, the basic embodiment including the three types of processing will be developed, and a unique developing embodiment that facilitates processing related to printer registration by the user will be described. A feature of the basic embodiment to be described in the first half is that a print job is transmitted to a printer via a dedicated service printer and a relay virtual printer. In contrast, a feature of the developing embodiment to be described in the latter half is that a print job is transmitted to a printer via a general-purpose service printer and a relay virtual printer.

Hereinafter, the three types of processing will be described as the first-half basic embodiment.

The first processing is pre-registration processing in which an administrator registers the printer 110 to the print relay server 120 to realize a relay virtual printer 323 in the print relay server 120.

The second processing is main registration processing in which a user registers the relay virtual printer 323 managed by the print relay server 120 to a print service 330 of the print server group 130 through a print service proxy 325.

The third processing is print processing in which print data generated by the print server group 130 according to an instruction of the user is printed by the printer 110 via the print relay server 120.

Here, the administrator means an administrator of a tenant where the printer 110 is installed. Also, the user means a user who prints a document using the printer 110, the document having been created with a Web application 350 using the content print system 1000.

First, the pre-registration processing as the first processing will be described. First, a function classified into the pre-registration processing included in the printer 110 will be described. The printer 110 includes a print controller 310. The print controller 310 registers a printer in operation to the print relay server 120 according to a screen operation by the administrator.

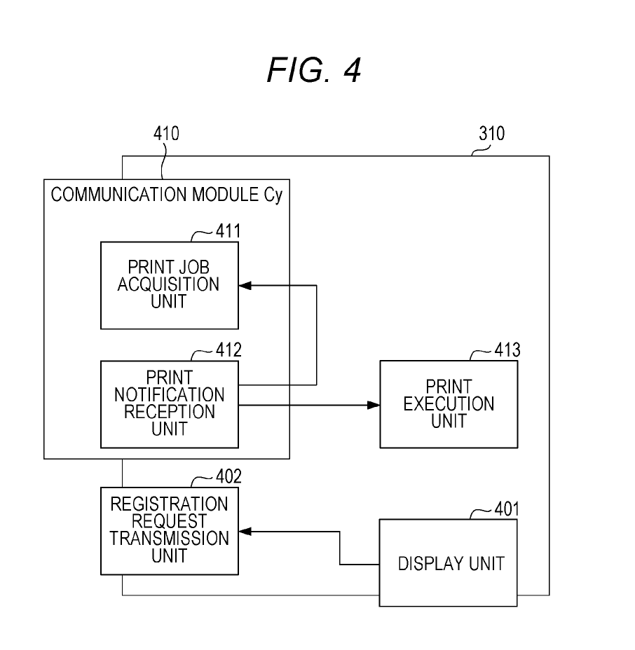

Hereinafter, a function of the print controller 310 will be described with reference to FIG. 4.

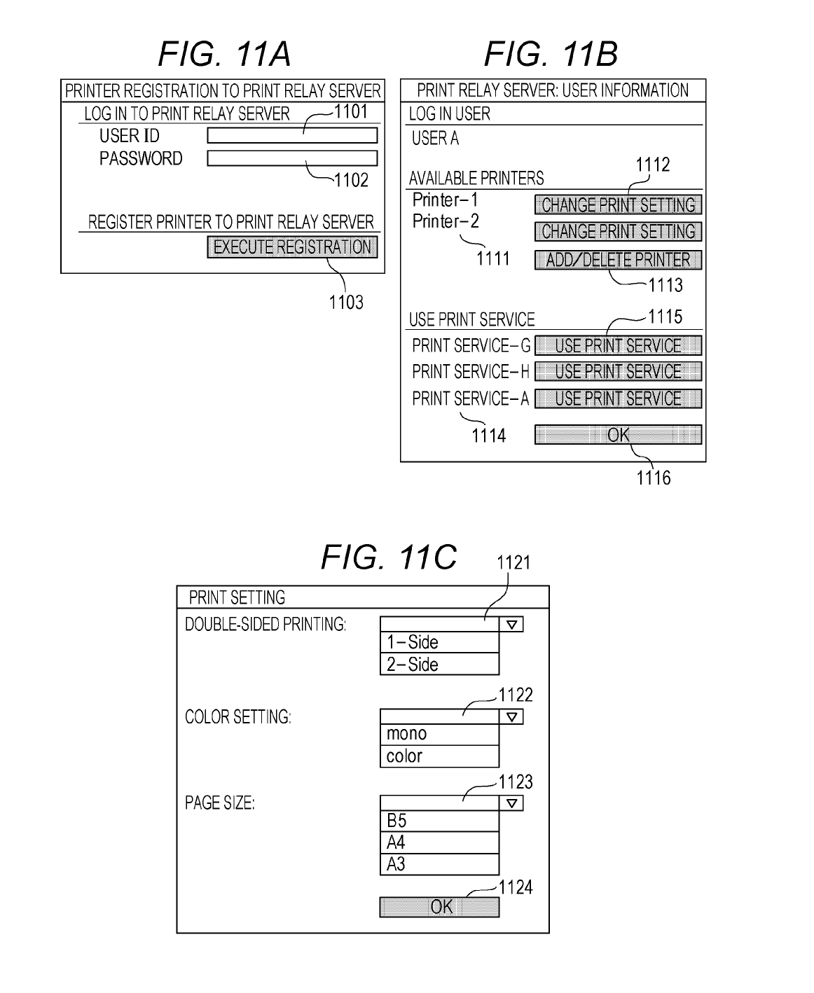

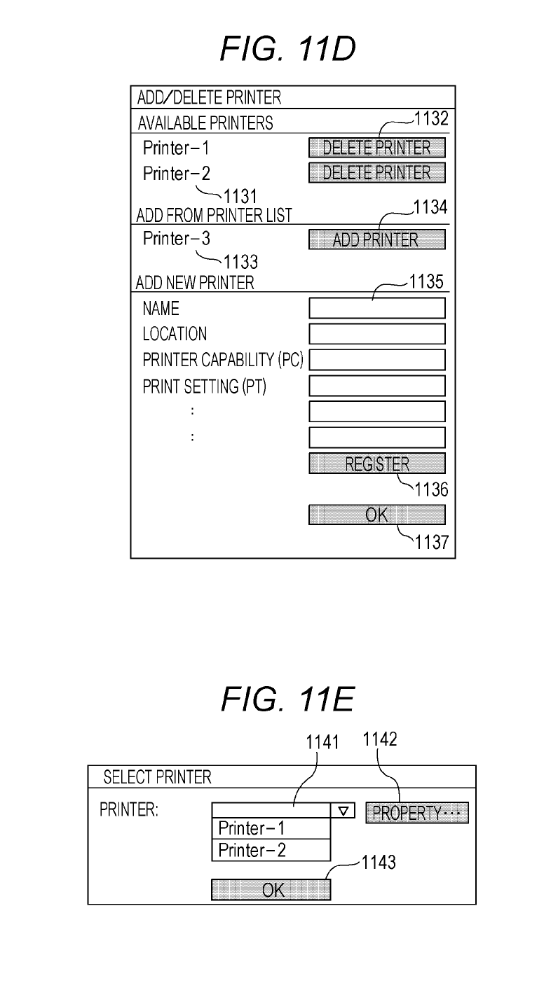

A display unit 401 displays various types of screens. Here, the display unit 401 displays a user interface (UI) exemplarily illustrated in FIG. 11A. The administrator can instruct registration of the printer 110 to the print relay server 120 through the UI. Note that a URL or an IP address of a print relay server may also be input. If it can be input, registration to any print relay server becomes possible. Note that, in the embodiments of the present disclosure, an internally recorded value of the URL or the IP address is used.

Here, when the administrator inputs a user ID 1101 and a password 1102 for logging in the print relay server 120, and presses a registration execution button 1103, the display unit 401 transmits input information to a registration request transmission unit 402 and instructs registration execution. The registration request transmission unit 402 first logs in the print relay server 120 using the received input information, and if succeeds, transmits registration information of a printer to the print relay server 120. Note that a registration instruction may be provided from the print relay server 120 as described below instead of the printer 110.

Here, the registration information will be described. The registration information includes a real printer ID (RPID) that is unique identification information allocated to the printer 110. The unique identification information is allocated to each of a plurality of printers (not illustrated) that includes the printer 110, and each printer can be identified with the identification information. In Embodiment 1, an arranged location of a printer can be identified by identifying the RPID.

Further, the registration information includes a printer name of the printer 110. The printer name is a name allocated to the printer 110, and is used when the printer 110 is called. Note that there may be a plurality of printers having an identical printer name, which is different from the identification number.

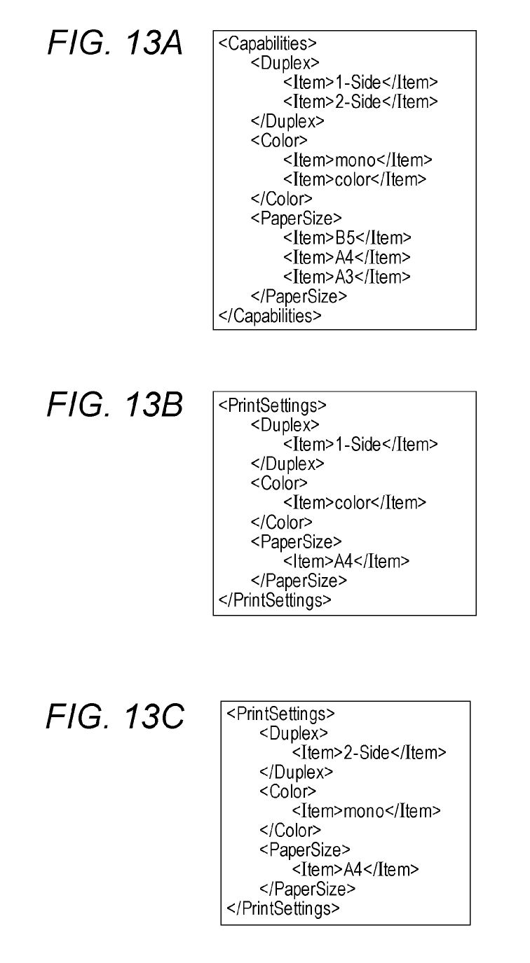

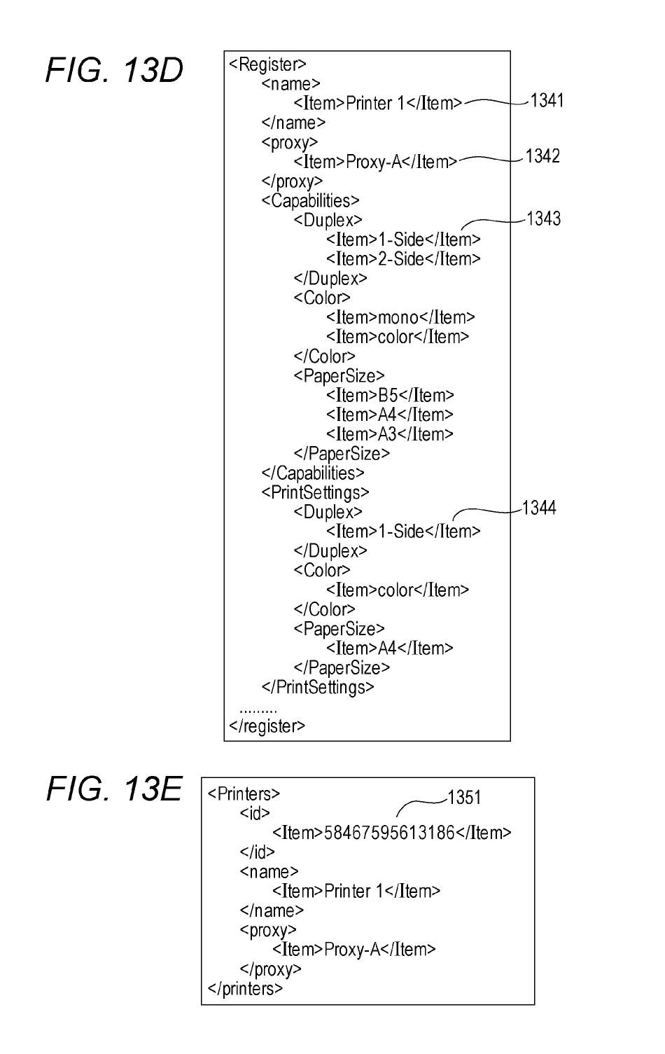

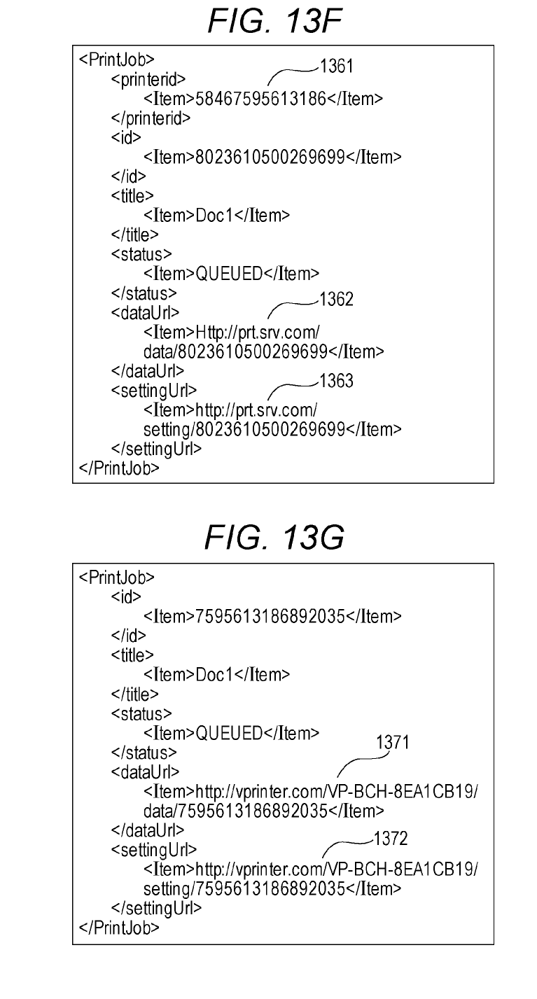

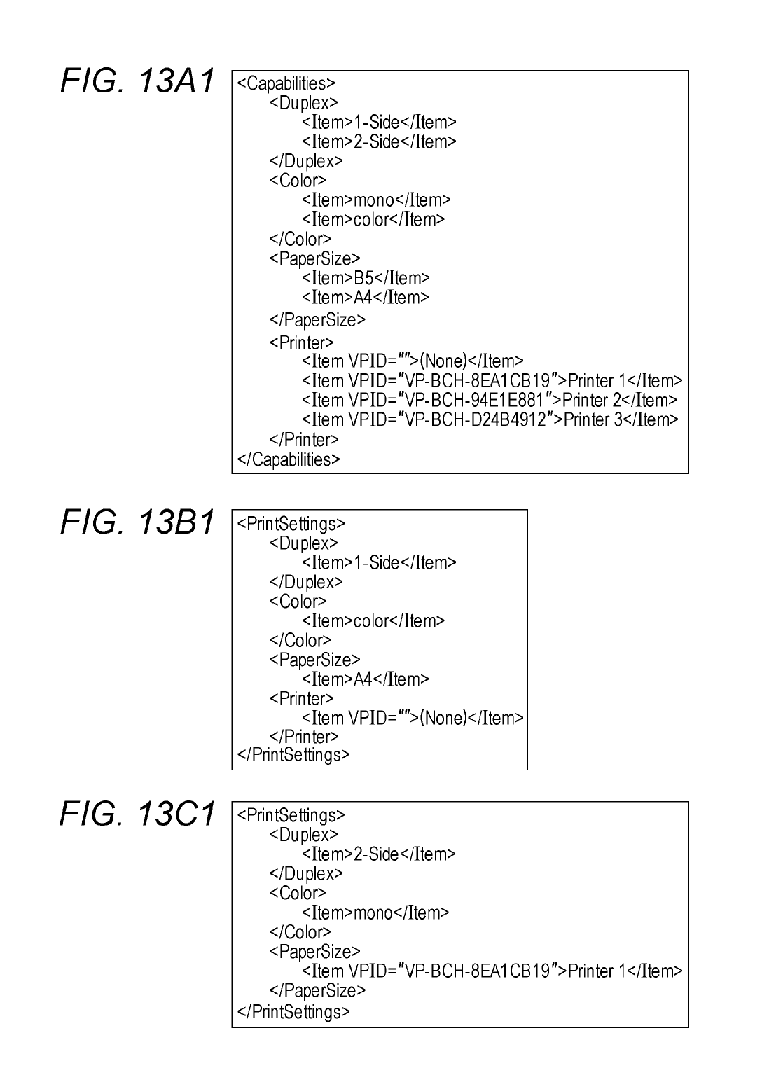

Further, the registration information includes capabilities. The capabilities refer to, for example, capability information of a printer such as whether the printer 110 is capable of double-sided printing, whether the printer 110 is capable of color printing, and printable paper sizes. The capabilities can be expressed in an XML format as illustrated in FIG. 13A. The <Item> indicates the capabilities of the printer 110, and indicates that the printer 110 is capable of double-sided printing and color printing, and can print on papers of B5 size, A4 size, and A3 size.

Further, the registration information includes a print setting initial value. As illustrated in FIG. 13B, the registration information can be expressed in an XML format, and any one <Item> is selected in each print setting item. As illustrated in FIG. 13B, a single-sided output, a color output, and A4 size are set.

Next, a function classified into the pre-registration processing included in the print relay server 120 will be described. The print relay server 120 includes a relay virtual printer management service 322. The relay virtual printer management service 322 receives a printer registration request from the print controller 310, and generates the relay virtual printer 323.

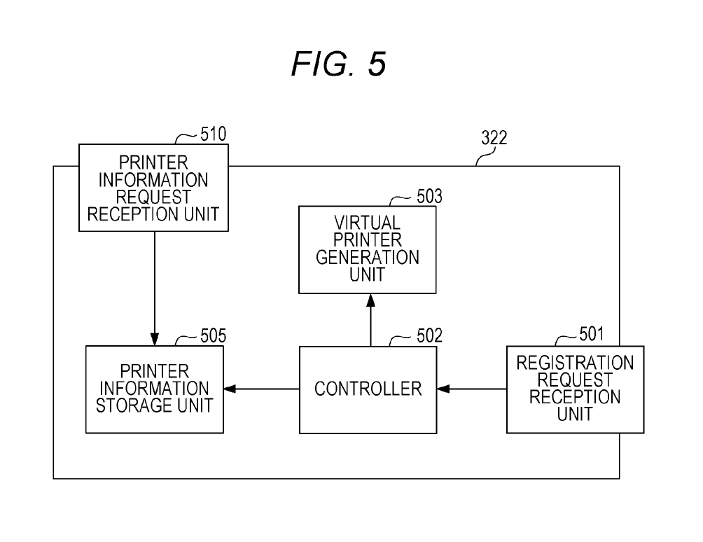

Hereinafter, a function of the relay virtual printer management service 322 will be described with reference to FIG. 5.

A registration request reception unit 501 receives the registration information transmitted from the registration request transmission unit 402. A controller 502 acquires the registration information received by the registration request reception unit 501, and interprets the registration information. The controller 502 outputs an instruction to generate the relay virtual printer 323 to a virtual printer generation unit 503. Note that, in FIG. 3, only one relay virtual printer 323 is illustrated for simplification. However, if a plurality of printers exists, the administrator can register a plurality of relay virtual printers corresponding to the plurality of printers.

The virtual printer generation unit 503 includes a communication module Cx610 conforming to a communication method with a target printer. The communication module Cx610 is an interface for communicating with the printer 110, and is capable of communicating with a communication module Cy410 included in the printer 110.

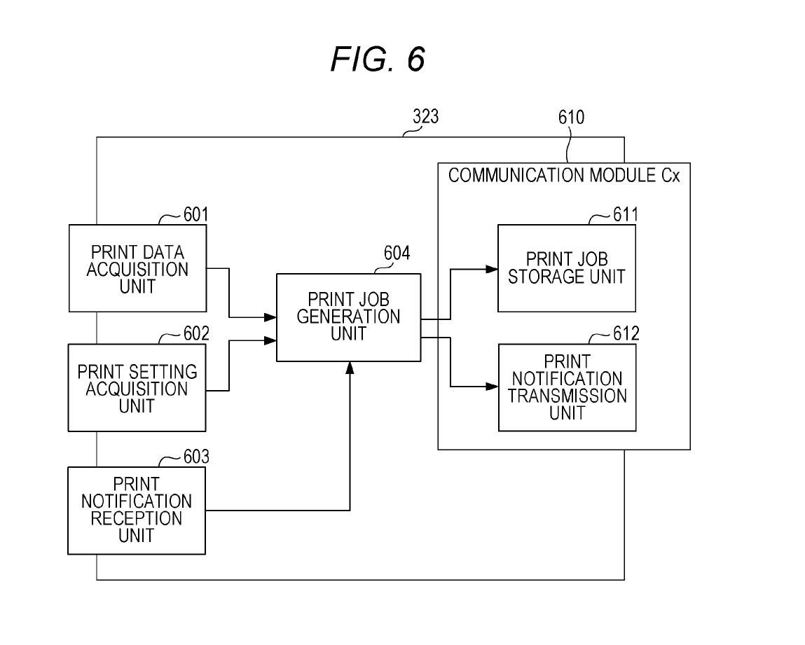

The virtual printer generation unit 503 realizes a process (thread) into which the communication module is loaded. This process corresponds to the relay virtual printer 323 that realizes the functions illustrated in FIG. 6. The relay virtual printer 323 includes a function as a communication module as well as a function to acquire print data upon receiving print notification, and a function to generate a print job from the print data. Details of each function will be described below.

Upon realizing the relay virtual printer 323, the virtual printer generation unit 503 issues a virtual printer ID (VPID) that is identification information for identifying the realized relay virtual printer 323. The issued VPID is transmitted to the controller 502. Note that the relay virtual printer 323 is realized every time the registration information is transmitted from the printer 110, and the VPID, which is a unique identifier, is allocated to each realized relay virtual printer 323. The embodiment of the present disclosure can identify the relay virtual printer 323 from among a plurality of registered relay virtual printers by identifying the VPID.

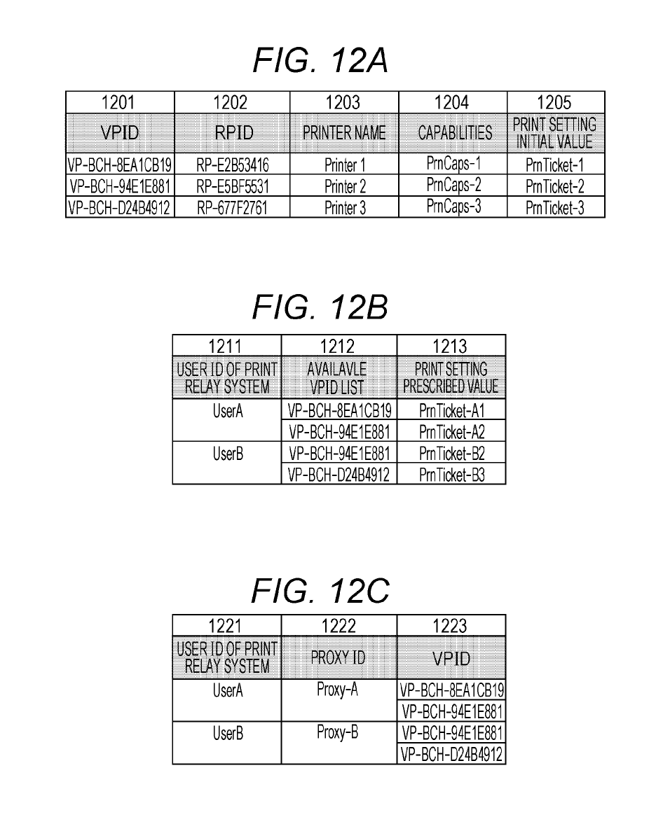

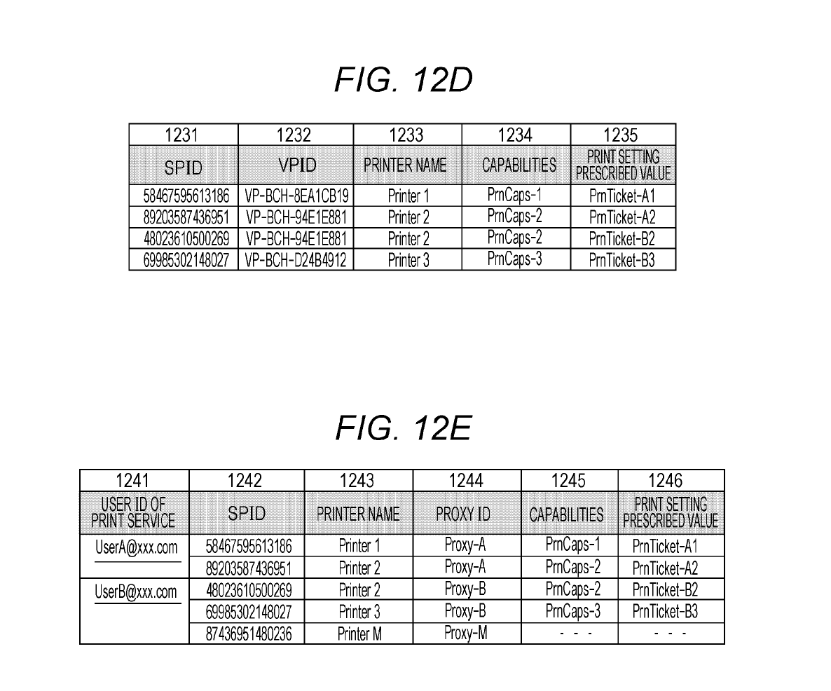

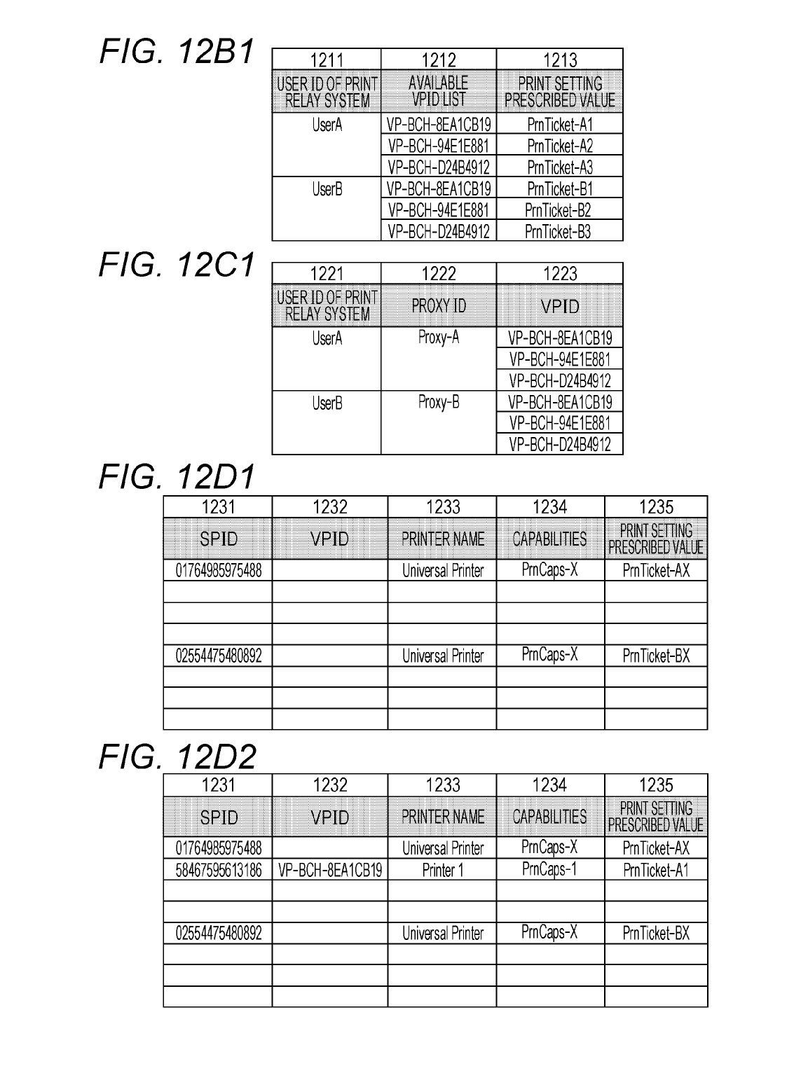

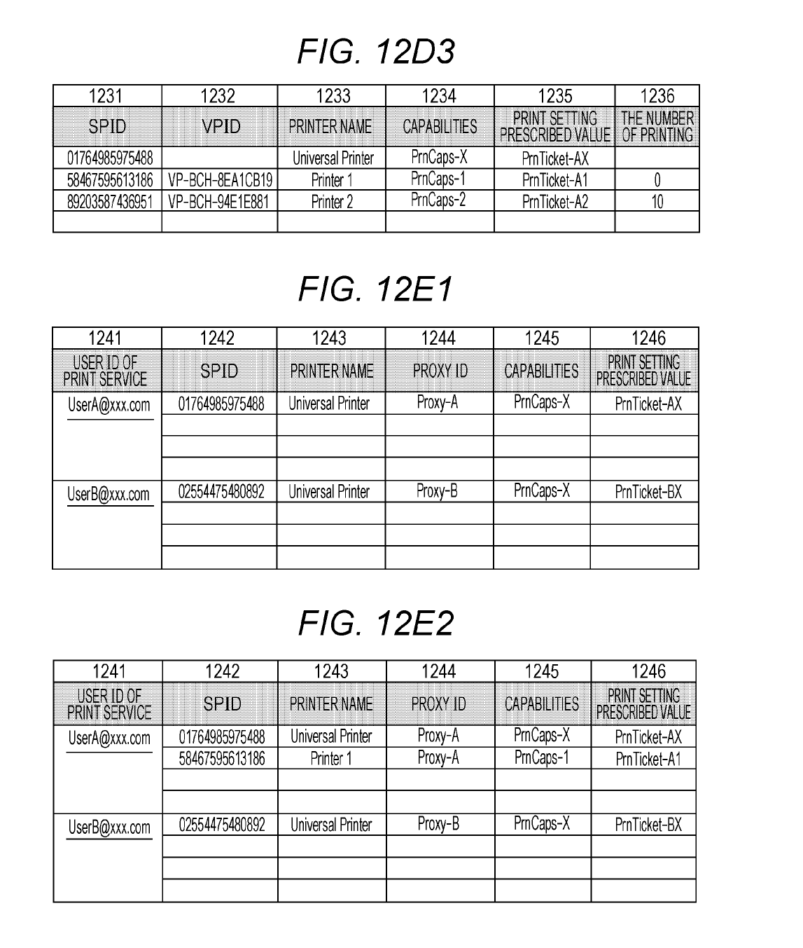

The controller 502 that has acquired the VPID from the virtual printer generation unit 503 instructs a printer information storage unit 505 to store the VPID and the registration information of the printer. The printer information storage unit 505 stores the VPID and the registration information in association with each other as illustrated in FIG. 12A. As the registration information stored by the printer information storage unit 505, the VPID corresponds to 1201, the RPID corresponds to 1202, the printer name corresponds to 1203, the capabilities corresponds to 1204, and a print setting prescribed value corresponds to 1205.

Note that the relay virtual printer 323 may have a structure in which the processing is theoretically divided and performed in a single process instead of individual processes. That is, any structure may be employed as long as a corresponding RPID can be controlling by identifying a VPID.

The pre-registration processing in which the administrator registers the printer 110 to the print relay server 120 to realize the relay virtual printer 323 in the print relay server 120 has been described above.

Next, the main registration as the second processing will be described. First, a function classified into the main registration included in the print relay server 120 will be described. The print relay server 120 includes a main processing management service 321. The main processing management service 321 is a common processing unit independent of the print service 330, and here, performs pre-processing for registering the relay virtual printer 323 to the print service 330 according to an instruction by the user.

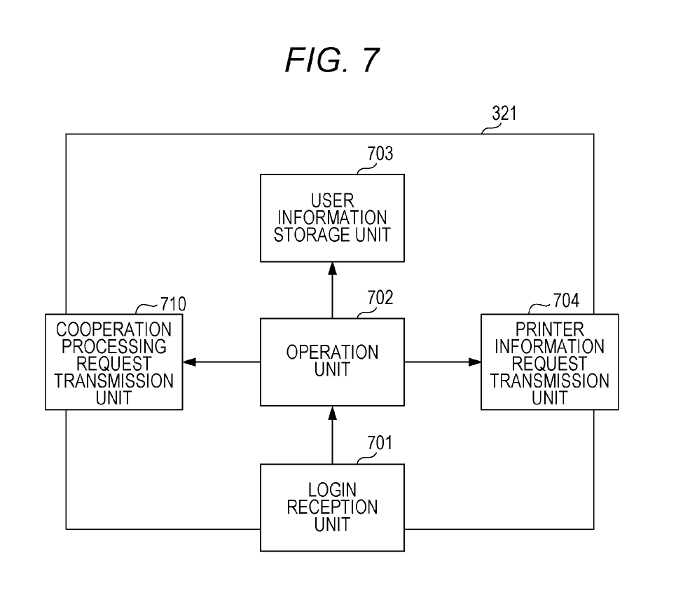

Hereinafter, a function of the main processing management service 321 will be described with reference to FIG. 7.

A login reception unit 701 receives a login performed by the user through a Web browser 340 of the client 140. When user authentication is completed, processing in accordance with a user account of the logged-in user is performed.

Next, an operation unit 702 displays a screen on which an operation by the user is received, as exemplarily illustrated in FIG. 11B. This screen is also generated based on information set for each user. A list of printers 1111 available for the user is displayed on FIG. 11B, and a print setting change button 1112 is arranged to each of the printers. Further, an addition/deletion button 1113 for managing printers available for the user is arranged. Further, a print service vender list 1114 is displayed, and there is a cooperation button 1115 for cooperating with each print service.

When the addition/deletion button 1113 is pressed, an addition/deletion screen of a printer exemplarily illustrated in FIG. 11D is displayed. Here, a list of printers 1131 already available for the user and a deletion button 1132 for deleting the printer are displayed. Further, a list of printers 1133 available in the print relay server 120 and use of which can be requested by the user, and an addition button 1134 for performing an addition request are displayed. Further, an information input box 1135 and a registration execution button 1136 with which the user newly registers a printer to the print relay server 120 are displayed. The information input box 1135 and the registration execution button 1136 are used for performing processing on an operation screen of a server, which is similar to the above-described processing performed in the registration request transmission unit 402 of the printer 110.

Here, when the user adds a printer, the operation unit 702 instructs the user information storage unit 703 to store a user ID, a VPID of a relay virtual printer corresponding to the printer, an addition of which has been requested, and print setting of the printers in association with each other, as illustrated in FIG. 12B. As the information to be stored, the user ID is denoted with 1211, the VPID with 1212, and a print setting prescribed value of the VPID with 1213. When the user performs addition/deletion of a printer, a printer 1212 associated with the user ID 1211 of the user is increased/decreased. The print setting prescribed value 1213 serves as a prescribed value when a printer is selected from the Web application 350 and print setting is performed.

Further, an initial value of the print setting prescribed value 1213 serves as the print setting initial value 1205 stored in FIG. 12A. A flow of acquiring the print setting is as follows. First, the operation unit 702 instructs a printer information request transmission unit 704 to request printer information to the relay virtual printer management service 322. At this time, a VPID of a printer, information of which is required, is passed. The relay virtual printer management service 322 receives the request by a printer information request reception unit 510. The printer information request reception unit 510 acquires information of FIG. 12A associated with the received VPID through the printer information storage unit 505. Here, the print setting initial value 1205 is acquired. The printer information request reception unit 510 transmits the acquired information to the printer information request transmission unit 704, and the printer information request transmission unit 704 transmits the acquired information to the operation unit 702. The print setting initial value is acquired in the above-described flow.

When an OK button 1137 is pressed by the used on a screen of FIG. 11D, available printers are confirmed, and the screen returns to the screen of FIG. 11B. On this screen, display of the available printers is renewed. As described above, the available printers for each user can be managed.

When the print setting change button 1112 is pressed by the user through a UI of FIG. 11B, the operation unit 702 instructs the printer information request transmission unit 704 to request acquisition of printer information to the relay virtual printer management service 322. At this time, a VPID of a relay virtual printer corresponding to a printer, information of which is required, is passed. The printer information request reception unit 510 of the relay virtual printer management service 322 receives a printer information request. The printer information request reception unit 510 acquires information of FIG. 12A associated with the received VPID through the printer information storage unit 505. Here, the capabilities 1204 are acquired. The printer information request reception unit 510 transmits the acquired information to the printer information request transmission unit 704, and the printer information request transmission unit 704 transmits the acquired information to the operation unit 702. Further, the operation unit 702 passes the VPID of the relay virtual printer corresponding to the printer, information of which is required, to the user information storage unit 703, and requests information. Here, the print setting prescribed value 1213 managed in FIG. 12B is acquired through the user information storage unit 703. As described above, the capabilities and the print setting of the selected printer are acquired.

Next, the operation unit 702 displays a print setting screen exemplarily illustrated in FIG. 11C. Here, setting items and selection options thereof are generated based on the acquired capabilities. Also, the acquired print setting prescribed value is applied to an initial setting thereof.

When the user changes the setting through a UI screen, a setting value thereof is held in an XML format like FIG. 13C. As illustrated in FIG. 13C, double-sided output, black-and-white output, and A4 size are set. When an OK button 1124 is pressed by the user, the setting is confirmed, and the operation unit 702 transmits the XML that holds the print setting and the VPID of the printer to the user information storage unit 703. The user information storage unit 703 renews the print setting prescribed value 1213 of the printer of the user with the received setting.

As described above, the print setting of each printer is managed for each user, and a different prescribed value can be held by each user even with the same printer.

When a cooperation button 1115 is pressed by the user in a UI of FIG. 11B, the operation unit 702 instructs a cooperation processing request transmission unit 710 to perform cooperation processing. The cooperation processing request transmission unit 710 transmits a cooperation processing request to a cooperation processing management service 324 corresponding to a selected print service 330. At this time, a user ID of the user, a VPID list of relay virtual printers corresponding to available printers to the user, and information related to each VPID are transmitted. The information related to each VPID required here is the printer name 1203 and the capabilities 1204 managed in the printer information storage unit 505, and the print setting prescribed value 1213 managed in the user information storage unit 703.

Next, a function classified into the main registration of the cooperation processing management service 324 included in the print relay server 120 will be described. The cooperation processing management service 324 exists for each print service, and creates a process that has an interface corresponding to a communication method with a print service. In the present embodiment, the print service proxy 325 is generated. Further, the cooperation processing management service 324 manages information necessary for communication and print execution.

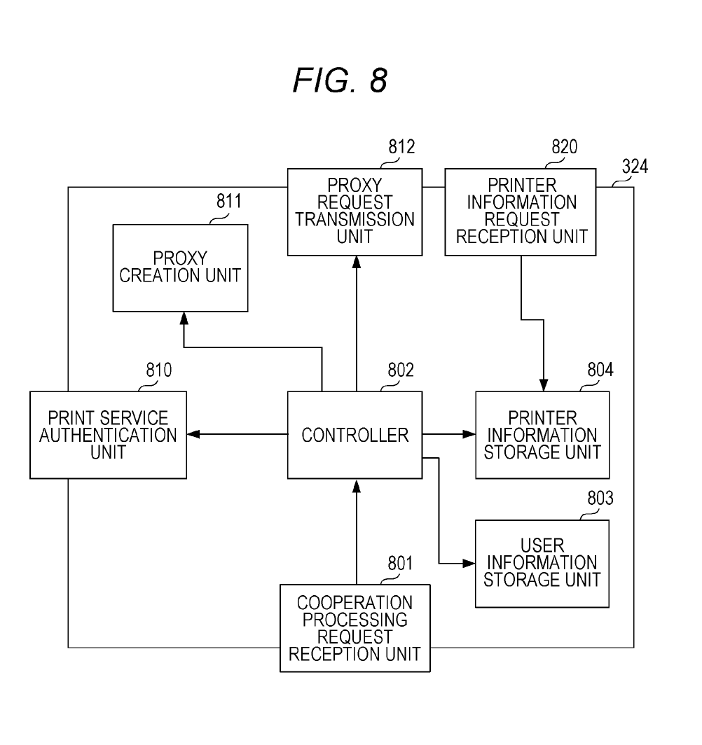

Hereinafter, a function of the cooperation processing management service 324 will be described with reference to FIG. 8.

A cooperation processing request reception unit 801 receives a request from the cooperation processing request transmission unit 710. Here, as information, a printer name, capabilities, and print setting are received. The cooperation processing request reception unit 801 transmits the received information to a controller 802. The controller 802 interprets the received information. The controller 802 instructs a user information storage unit 803 to confirm whether information managed by the user information storage unit 803 includes an appropriate user ID. Note that details of the information managed by the user information storage unit 803 will be described below.

When there is not the user ID, this means that the user first uses the print service 330. Therefore, user authentication of the user is performed with respect to a target print server group. Here, the controller 802 instructs a print service authentication unit 810 to login to the print server group 130. Here, the user inputs a user account (an ID or a password) for accessing the print service 330 on a login screen displayed by the print service 330. When the user authentication succeeds, the print service authentication unit 810 receives an authentication token from the print server group 130, and passes the authentication token to the controller 802. Note that, when the user authentication fails, this means that the user cannot use the print service 330, and therefore, the cooperation processing request reception unit 801 returns a status of failure to the cooperation processing request transmission unit 710.

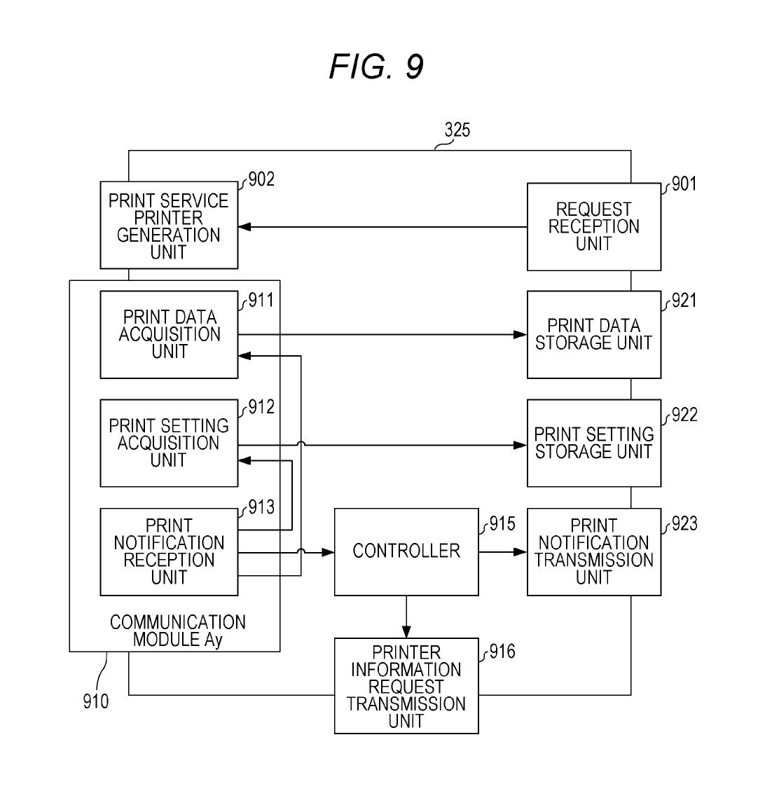

Next, the controller 802 instructs a proxy creation unit 811 to realize a function of the print service proxy 325. The print service proxy 325 realizes functions illustrated in FIG. 9. The proxy creation unit 811 includes a communication module Ay910 conforming to a communication method with a target print service 330. The communication module Ay910 is an interface for communicating with the print server group 130, and is capable of communicating with a communication module Ax1010 included in the print service 330 described below. The proxy creation unit 811 realizes a process (thread) into which the communication module is loaded. This process corresponds to the print service proxy 325. The print service proxy 325 includes a function to register a printer to the print service 330 and a function to transfer print data and print setting acquired from the print service 330 to other module other than the communication module. Details of the functions of the print service proxy 325 will be described below.

The proxy creation unit 811 issues, when having realized the print service proxy 325, a proxy ID that is identification information for identifying the realized print service proxy 325. The issued proxy ID is transmitted to the controller 802. Note that the print service proxy 325 is realized for each user ID, and a proxy ID, which is unique identification information, is allocated to each realized print service proxy 325. The embodiment of the present disclosure can identify the print service proxy 325 from the proxy ID.

Note that the proxy ID may be issued by the print service 330. At this time, the proxy ID received from the print service 330 is managed.

After the print service proxy 325 is created, the controller 802 instructs a proxy request transmission unit 812 to register a dedicated service printer corresponding to the relay virtual printer 323. A service printer is an object (printer object) that identifies the printer 110 on the print service. When the service printer is registered to the print service 330, the print service 330 issues a service printer ID (SPID) that is identification information for identifying the service printer. The dedicated service printer refers to a printer object that corresponds to the printer 110 one on one (dedicated printer object) among printer objects on the print service. The proxy request transmission unit 812 requests, to the print service proxy 325, registration of the dedicated service printer to the print service 330. At this time, an authentication token of the user, a proxy ID, a VPID list, and association information thereof are transmitted. As described below, when having performed the registration processing of the dedicated service printer, the print service proxy 325 replies with an SPID corresponding to each VPID. Details of the SPID will be described below. The proxy request transmission unit 812 that has received an SPID list replies to the controller 802 with information thereof.

As described above, when the proxy creation unit 811 and the proxy request transmission unit 812 have completed the processing, the controller 802 acquires the proxy ID of the generated print service proxy 325 and the SPID list corresponding to the VPID registered in the print service 330. The controller 802 instructs the user information storage unit 803 to store the user ID managed in the print relay server 120, the proxy ID to the print service 330, and the association information in association with each other like FIG. 12C. Note that the user ID corresponds to 1221, the proxy ID corresponds to 1222, and the VPID list available for the user corresponds to 1223. Further, the controller 802 instructs a printer information storage unit 804 to store the SPID, the VPID, and the association information in association with each other like FIG. 12D. Note that the SPID corresponds to 1231, the VPID corresponds to 1232, the printer name corresponds to 1233, the capabilities correspond to 1234, and the print setting prescribed value corresponds to 1235.

Note that, when the user who has already created the print service proxy 325 uses the cooperation processing management service 324 again, the above processing of the proxy creation unit 811 is skipped. In that case, the controller 802 confirms whether there is a difference between the VPID list received from the cooperation processing request reception unit 801 and the VPID list associated with the user and stored in the user information storage unit 803 by comparing these VPID lists. When there is a difference, this means that a printer corresponding to the relay virtual printer registered in the print service 330 and a printer available for the user do not match. Therefore, the controller 802 confirms a VPID to be added and a VPID to be deleted, and instructs the proxy request transmission unit 812 to perform addition/deletion of the printers.

Next, a function classified to main registration series of the print service proxy 325 included in the print relay server 120 will be described. The print service proxy 325 is a process having a communication interface corresponding to a communication method with the print service 330. When there is a plurality of print services, the cooperation processing management service 324 generates the print service proxy for each user account with respect to each of the print services. Then, each generated print service proxy is individually connected to each print service, so that all users are simultaneously connected to all print services. Here, processing to register a dedicated service printer corresponding to the relay virtual printer 323 to the print service 330 is performed.

Hereinafter, a function of the print service proxy 325 will be described with reference to FIG. 9.

A request reception unit 901 receives a registration request of a dedicated service printer corresponding to the relay virtual printer 323, and an authentication token of the user, a proxy ID, a VPID list, and association information thereof from the proxy request transmission unit 812. The request reception unit 901 instructs a print service printer generation unit 902 to perform registration processing. The print service printer generation unit 902 is connected to the print service 330 using the received authentication token, and keeps the connection. Next, the print service printer generation unit 902 performs a registration request of the dedicated service printer to the print service 330 based on the received information. FIG. 13D is an example of the registration request information to the print service 330, and includes a printer name 1341, a proxy ID 1342, capabilities 1343, and print setting 1344 in the information written in an XML format. Although information for one printer is written here, a plurality of printers may be registered by one registration request.

The print service printer generation unit 902 receives an SPID from the print service 330 as a response to the registration request. FIG. 13E is an example thereof written in an XML format, and an SPID 1351 corresponding to the dedicated service printer is allocated. Although information of one printer is written here, a plurality of printers may be responded by one reply. The print service printer generation unit 902 replies to the request reception unit 901 with the received SPID, and the request reception unit 901 replies to the proxy request transmission unit 812 with the information.

Here, there is a problem in that, if the print relay server 120 holds user account information (a user ID or a password) for connecting to each print service, it is not favorable for securities reasons. However, as described above, after logging in to a print service, connection continues using an authentication token. This makes it unnecessary to hold user account information of the print service on the print relay server 120, resulting in an effect of reducing security risks.

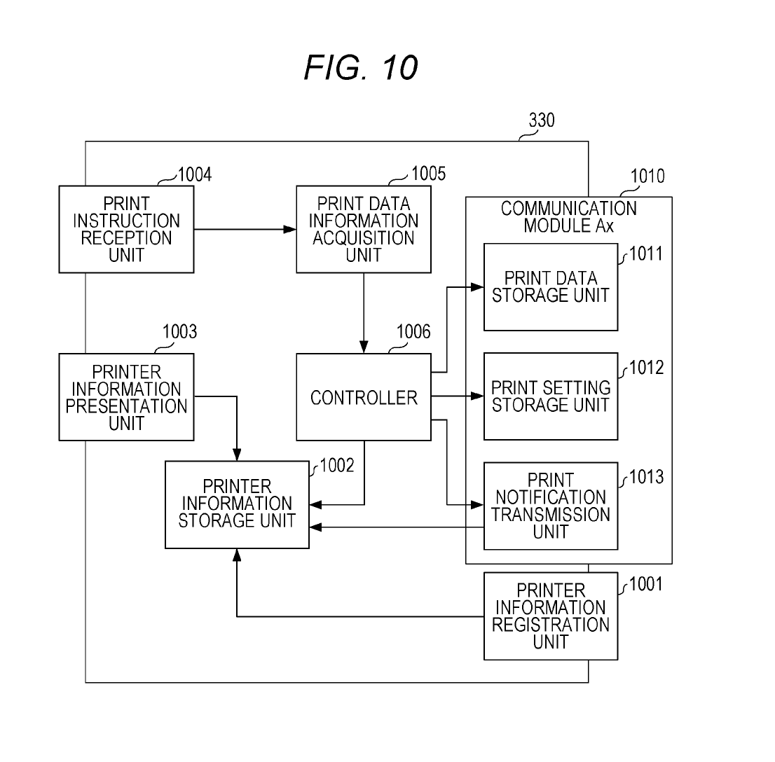

The print service 330 receives a registration request of the dedicated service printer corresponding to the relay virtual printer 323 from the user. After receiving the registration request, the print service 330 registers, within the print service 330, the dedicated service printer that is a printer object selectable from the Web application 350. Hereinafter, a function of the print service 330 will be described with reference to FIG. 10.

A printer information registration unit 1001 receives a printer registration request and association information thereof from the print service printer generation unit 902. The printer information registration unit 1001 creates a dedicated service printer corresponding to each relay virtual printer, the registration request of which has been given, based on the received information, and issues an SPID of each dedicated service printer.

Here, the service printer ID (SPID) will be described. Upon receiving the registration request of a dedicated service printer of the printer 110, the print service 330 issues an SPID that is identification information for identifying the dedicated service printer. When the dedicated service printer is selected at the time of printing, the print service 330 identifies the relay virtual printer 323 with the SPID of the selected dedicated service printer.

The SPID issued by the print service 330 is transmitted to a printer information storage unit 1002 and to the print service printer generation unit 902.

The printer information storage unit 1002 stores the user ID in the print service 330, and the SPID, the printer name, the proxy ID, the capabilities, and the print setting in association with each other. FIG. 12E is a diagram illustrating information stored in the printer information storage unit 1002, and the user ID corresponds to 1241, the SPID corresponds to 1242, the printer name corresponds to 1243, the proxy ID corresponds to 1244, the capabilities corresponds to 1245, and the print setting corresponds to 1246.

Note that, when registration of a printer is performed through an interface having a different proxy ID like information managed by UserB@xxx.com exemplarily illustrated in FIG. 12E, it is managed such that which printer is registered from which print service proxy can be known.

The above is the function classified into the main registration in which the user registers the relay virtual printer 323 managed by the print relay server 120 to the print service 330 through the print service proxy 325.

Next, print processing will be described, in which the user causes the printer 110 to print print data created by the Web application 350. First, a function included in the client 140 will be described. The client 140 includes the Web browser 340.

The Web browser 340 transmits a print instruction of content stored in the Web application server group 150 to the Web application server group 150. Also, the Web browser 340 receives, from the Web application server group 150, an access command to the print server group 130, that is, an instruction of redirect, and accesses the print server group 130 according to the received instruction of redirect. Further, the Web browser 340 acquires a list of printers available for the user who uses the Web browser 340 from the accessed print server group 130, and displays the list (first display control unit). Further, the Web browser 340 acquires, from the print server group 130, a print setting screen corresponding to the printer 110 selected by the user from the list, and displays the print setting screen (second display control unit). FIG. 11C is an example of the print setting screen that corresponds to the printer 110 selected by the user and that is displayed by the Web browser 340. Further, the Web browser 340 transmits a print setting value set by the user on the print setting screen to the print server group 130.

The Web browser 340 included in the client 140 has been described above.

Next, a function included in the Web application server group 150 will be described. The Web application server group 150 includes the Web application 350. The Web application server group 150 virtualizes a plurality of servers, regards them as one server, and realizes the function of the Web application 350 with the one server. Note that the Web application server group 150 starts a plurality of virtual machines in the one server, and causes each of the virtual machines to realize the function of the Web application 350.

The Web application 350 provides a document creation service. When the user wants to distribute a document in a company meeting, for example, the user uses the document creation service for creating the document. When the document is created using the Web application 350, it is not necessary for the user to install an application thereof to the client 140, and the client 140 may just include the Web browser 340. The Web application 350 transmits screen information for creating the document to the Web browser 340. Note that the Web application 350 performs authentication based on user information including a user ID and a password input by the user via the Web browser 340, and transmits the screen information for creating the document in response to success of the authentication. The Web browser 340 that has received the screen information displays a creation display for creating a document based on the screen information, and the user creates the document to be distributed in the meeting using the creation display. The Web application 350 receives information of the document created by the user using the creation display, creates content based on the received information, and stores the created content in a storage device of the Web application server group 150. Note that the Web application 350 provides not only the document creation service but also a mailing service and a scheduling service.

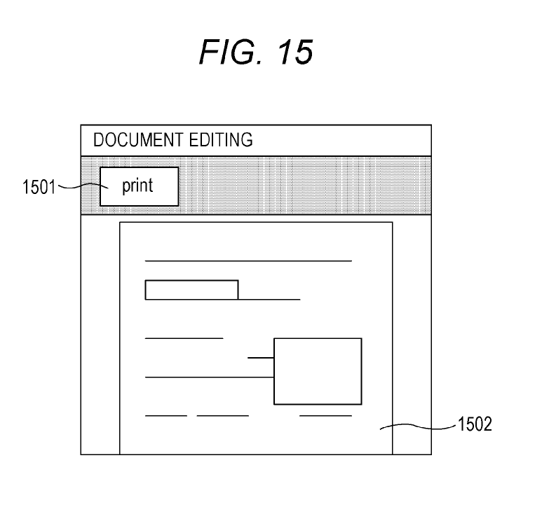

The user who wants to print the created content using the document creation service presses a print button displayed on the creation display. FIG. 15 illustrates a print button 1501 being pressed. Note that the content created by the user is 1502. The Web application 350 receives information that the print button has been pressed, and transmits, to the Web browser 340, an access command to the print server group 130, that is, an instruction of redirect. Note that the instruction of redirect includes a request for acquiring a list of the printers 110 available for the user who uses the Web browser 340, content identification information for identifying the content, printing of which is instructed by the user, and user information. Further, when there is an acquisition request of the content from the print server group 130, the Web application 350 transmits the target content to the print server group 130 based on content identification information for identifying the content transmitted with the acquisition request.

The Web application 350 included in the Web application server group 150 has been described above.

Next, a function classified into the print processing included in the print server group 130 will be described. The print server group 130 includes the print service 330. The print service 330 acquires print data from the Web application 350, transmits the print data to the printer 110 or to a module having an interface conforming to the printer 110, and performs printing.

Hereinafter, a function of the print service 330 will be described with reference to FIG. 10.

The print service 330 includes a printer information presentation unit 1003. The printer information presentation unit 1003 transmits a printer list to the Web browser 340 in response to the acquisition request of a list of printers available for the user received from the Web browser 340. Note that the printer information presentation unit 1003 identifies an SPID and a printer name stored in the printer information storage unit 1002 based on the user information of the user. Then, the printer information presentation unit 1003 generates a list of printers available for the user based on the SPID and the printer name.

FIG. 11E illustrates a list of printers available for the user. FIG. 11E is an example of a list window of available printers presented to the user “UserA@xxx.com” of the print service 330. In a list box 1141, printer names of the printers available for the user are listed. When a property button 1142 is pressed, a print setting screen described below is called. When an OK button 1143 is pressed, a dedicated service printer selected and input at the list box 1141 is determined as an output destination.

When the property button 1142 is pressed, the printer information presentation unit 1003 identifies an SPID of the dedicated printer selected and input at the list box 1141. The printer information presentation unit 1003 identifies the capabilities stored in the printer information storage unit 1002 based on the identified SPID, generates a print setting screen, and transmits the generated print setting screen to the Web browser 340. Further, the printer information presentation unit 1003 identifies the print setting prescribed value stored in the printer information storage unit 1002 based on the received SPID, and causes the value to be an initial value.

The printer information storage unit 1002 generates a print setting screen illustrated in FIG. 11C from information of the capabilities illustrated in FIG. 12E. As illustrated in FIG. 11C, the printer information storage unit 1002 generates a print setting screen such that only the print setting written in the capabilities can be selected. Further, when the administrator adds the function of the printer 110, and renews the information of the capabilities of the printer 110, the information stored in the printer information storage unit 1002 is renewed. The printer information presentation unit 1003 generates a print setting screen based on the renewed information in the printer information storage unit 1002.

A print instruction reception unit 1004 receives the print setting set via the print setting screen and the SPID from the Web browser 340. Further, when having been accessed by the Web browser 340 based on the instruction of redirect, the print instruction reception unit 1004 receives content identification information for identifying the content, printing of which is instructed by the user.

A print data information acquisition unit 1005 receives the content identification information from the print instruction reception unit 1004, and acquires the content to be a print target from the Web application 350 based on the received content identification information. Further, the print data information acquisition unit 1005 receives the print setting input by the user and the SPID corresponding to the dedicated service printer selected by the user from the print instruction reception unit 1004. Note that the print data information acquisition unit 1005 may convert the content into print data as necessary based on the content and the print setting acquired from the Web application 350.

A controller 1006 acquires the print data, the print setting, and the SPID from the print data information acquisition unit 1005. The print setting is written in an XML format like FIG. 13C. According to FIG. 13C, it can be known that the user has set the double-sided setting, the black-and-white setting, and the paper size A4.

A communication module Ax1010 is capable of communicating with a device that has the communication module Ay910, and serves as an interface of data communication between the module Ax1010 and the device. The communication module Ax1010 includes a print data storage unit 1011, a print setting storage unit 1012, and a print notification transmission unit 1013. The print data storage unit 1011 receives the print data from the controller 1006, and stores the print data. The print setting storage unit 1012 receives the print setting from the controller 1006, and stores the print setting. The controller 1006 instructs the print notification transmission unit 1013 to transmit notification information in response to reception of completion of the storage from the print data storage unit 1011 and the print setting storage unit 1012.

The print notification transmission unit 1013 acquires a storage location of the print data and a storage location of the print setting from the controller 1006 in response to the instruction of transmitting the notification information from the controller 1006, and generates notification information A. The notification information A is expressed in an XML format illustrated in FIG. 13F, the SPID is written in 1361, the storage location of the print data is written in 1362, and the storage location of the print setting is written in 1363. Further, the print notification transmission unit 1013 acquires the SPID from the controller 1006, and identifies a proxy ID based on the information stored in the printer information storage unit 1002. The print notification transmission unit 1013 transmits the notification information A to an interface having the identified proxy ID in order to notify that preparation of the print data to the SPID managed by the proxy is ready.

This communication information A conforms to a communication method unique to the print service, and it is necessary to implement an interface that can accept the unique communication method for communication. If the interface is implemented into a printer, the printer can be directly registered to a print server, and if the interface is implemented into a device such as a server or a client, which is capable of communication, the device can be registered as a proxy. In the embodiment of the present disclosure, the communication module Ay910 implements the interface that can accept the unique communication method, and can communicate with the communication module Ax1010.

Note that a mechanism in which the communication module Ax and the communication module Ay can communicate with each other is referred to as a specification of a vender who provides the print server group 130. Also, this specification profoundly depends on the vender who manages the print server group 130. The vender who manages the print server group 130 implements the communication module Ax in the print server group 130, and makes available to public the specification of the communication module Ay for communicating with the communication module Ax. Also, the specification of the data communication made available to public by the vender who manages the print server group 130 corresponds to a first specification. Interfaces of the communication module Ax and the communication module Ay are created according to the first specification. Further, the communication module Ay corresponds to a first communication unit.

Note that an existing printer has a problem in that, if it does not implement a dedicated interface, the existing printer cannot connect with a print service having a different communication specification. However, this problem is solved by using a function classified into a printing series of the print relay server 120 described below.

Next, a function classified into print processing of the print relay server 120 will be described. First, a function classified into print processing of the print service proxy 325 will be described. The print service proxy 325 receives the print notification and the SPID from the print service 330, and identifies a VPID corresponding to the SPID. Further, the print service proxy 325 receives print data from the print service 330, and performs printing by transmitting the print data to the relay virtual printer 323 corresponding to the identified VPID.

Hereinafter, a function of the print service proxy 325 will be described with reference to FIG. 9.

The print service proxy 325 includes a communication module Ay910. A print notification reception unit 913 of the communication module Ay910 receives the notification information A transmitted from the print notification transmission unit 1013. Since the relay virtual printer 323 is registered in the print service 330 through the print service proxy 325, the notification information A is transmitted to the communication module Ay910 of the print service proxy 325. Since the communication module Ay makes a pair with the communication module Ax, the print notification reception unit 913 can interpret the notification information A.

The print notification reception unit 913 instructs a controller 915 to identify the relay virtual printer 323 corresponding to the printer 110 that outputs the print data. The controller 915 first acquires an SPID of a service printer from the print notification information A. This SPID is an SPID 1361 of the print notification information A illustrated in FIG. 13F. Next, the controller 915 requests a VPID value corresponding to the SPID to a printer information request transmission unit 916. The printer information request transmission unit 916 requests printer information corresponding to the SPID to the cooperation processing management service 324. The printer information request reception unit 820 of the cooperation processing management service 324 receives the request, acquires information associated with the designated SPID from the printer information storage unit 804, and replies to the printer information request reception unit 820 with the information. The printer information request reception unit 820 replies to the printer information request transmission unit 916 with the information. The printer information request transmission unit 916 acquires the VPID value from among the acquired information, and transmits the value to the controller 915. The controller 915 transmits the acquired VPID to a print notification transmission unit 923. The print notification transmission unit 923 identifies the relay virtual printer 323 to which the data is transmitted from the acquired VPID.

Further, the print notification reception unit 913 confirms a storage location of the print data and a storage location of the print setting written in the notification information A, and notifies a print data acquisition unit 911 and a print setting acquisition unit 912 of respective information thereof. The print data acquisition unit 911 acquires the print data from the print data storage unit 1011 based on the notified storage location of the print data, and instructs a print data storage unit 921 to store the data. The print data storage unit 921 that has stored the print data notifies the print notification transmission unit 923 of the storage location. Further, the print setting acquisition unit 912 acquires the print setting from the print setting storage unit 1012 based on the notified storage location of the print setting, and instructs a print setting storage unit 922 to store the print setting. The print setting storage unit 922 that has stored the print setting notifies the print notification transmission unit 923 of the storage location.

The print notification transmission unit 923 generates notification information B in response to reception of the notification of the storage locations from the print data storage unit 921 and from the print setting storage unit 922. The notification information B can be expressed in an XML format illustrated in FIG. 13G. The storage location of the print data is written in 1371, and the storage location of the print setting is written in 1372. The print notification transmission unit 923 transmits the notification information B to a print notification reception unit 603 of the relay virtual printer 323 identified by the controller 915. This notification information B corresponds to a second specification, and is used for communication between the print service proxy 325 and the relay virtual printer 323. The print service proxy 325 and the relay virtual printer 323 exist in the print relay server 120, and communication becomes possible with any combination. Here, although the second specification is an internal format of the print relay server 120, implementation of the print service proxy 325 and a data format to be treated profoundly rely on the print service 330, and therefore, the second specification is a high general-purpose format. Further, the print notification transmission unit 923 and the print notification reception unit 603 correspond to a second communication unit.

Note that, there is a problem in that, when a printer including a communication module is directly registered to a print service, push printing cannot be performed by a user other than a user with a user account connected to the printer. Further, when the user account is periodically changed over and is re-connected at the printer side, it takes time until a specific user's turn comes, and printing cannot be done immediately. However, as described in the function classified into the main registration of the print service proxy 325, the print service proxy 325 is independently connected to the print service 330 for each print service 330 and for each user ID. Therefore, when the print service 330 is ready for preparation of printing for a specific user, the print service proxy 325 can immediately receive print data thereof. Also, the push printing can be performed to each printer by printing series processing of the relay virtual printer 323 described below. Therefore, the above problem is solved.

Next, a function classified into the print processing of the relay virtual printer 323 of the print relay server 120 will be described. The relay virtual printer 323 receives print data from the print service proxy 325, generates a print job based on simultaneously received print setting, and transmits the print job to the printer 110, so that printing is performed.

Hereinafter, a function of the relay virtual printer 323 will be described with reference to FIG. 6.

The print notification reception unit 603 receives the notification information B from the print notification transmission unit 923. The print notification reception unit 603 confirms storage locations of the print data and the print setting written in the notification information B, and notifies a print data acquisition unit 601 and a print setting acquisition unit 602 of information thereof, respectively.

The print data acquisition unit 601 acquires the print data from the print data storage unit 921 based on the notified storage location of the print data. The print setting acquisition unit 602 acquires the print setting from the print setting storage unit 922 based on the notified storage location of the print setting.

The print job generation unit 604 receives the print data from the print data acquisition unit 601 and the print setting from the print setting acquisition unit 602, respectively, and generates a print job in accordance with printer capability and the print setting. The printer capability here includes a print data format that is acceptable by a printer and information as to whether the printer itself can download the print data from a designated location. This is written in the capabilities 1204 in the capability information of printers managed by the relay virtual printer management service 322 illustrated in FIG. 12A. Therefore, if the printer 110 can interpret the print data received by the print data acquisition unit 601, the print data may be treated as the print job without being subjected to conversion.

The print job generation unit 604 stores the generated print job in a print job storage unit 611, and notifies the print notification transmission unit 612 of a storage location. The print notification transmission unit 612 generates notification information C including the storage location, and transmits the notification information C to the printer 110. The communication module Cy410 corresponding to the communication module Cx610 is implemented in the printer 110.

As described above, the printer 110 is configured to acquire the print data from the print server group 130 via the print relay server 120. With this configuration, even if the printer 110 does not have a communication module fitted to a print service vender, or even when the printer 110 accepts a new print service vender, a device vender need not change the communication module of the printer 110. The device vender can allow the printer 110 arranged in various user environments to communicate with the print server group 130 by changing the print service proxy 325 of the print relay server 120. A method of changing the print service proxy 325 includes a method of changing the communication module Ay of the print service proxy 325 as well as a method of rejecting the existing print service proxy 325 and of newly generating a print service proxy 325.

Further, in the relay virtual printer 323, the print data generated by the print service 330 can be converted into a format that is acceptable by the printer 110 that the user wants to use.

Next, a function classified into print processing of the printer 110 will be described.

The print controller 310 of the printer 110 receives the print data from the relay virtual printer 323, and executes printing.

Hereinafter, a function of the print controller 310 will be described with reference to FIG. 4.

The print controller 310 includes the communication module Cy410. A print notification reception unit 412 of the communication module Cy410 receives the notification information C transmitted from the print notification transmission unit 612. The communication module Cy is a module making a pair with the communication module Cx, and is therefore capable of interpreting the notification information C. Note that a specification predefined by the device vender in order to perform data communication between the relay virtual printer 323 and the printer 110 can be handled by the device vender. Interfaces of the communication module Cx and of the communication module Cy are created according to the specification.

The print notification reception unit 412 confirms a storage location of the print job written in the notification information C, and notifies a print job acquisition unit 411 of information thereof. The print job acquisition unit 411 acquires the print job from the print job storage unit 611 based on the notified storage location of the print job. The print notification reception unit 412 transmits the print job acquired by the print job acquisition unit 411 to a print execution unit 413, and instructs execution of printing. The print execution unit 413 that has received the instruction instructs a print unit to output the received print job.

The print processing in which the user prints print data generated in the print server group 130 using the printer 110 through the print relay server 120 has been described above.

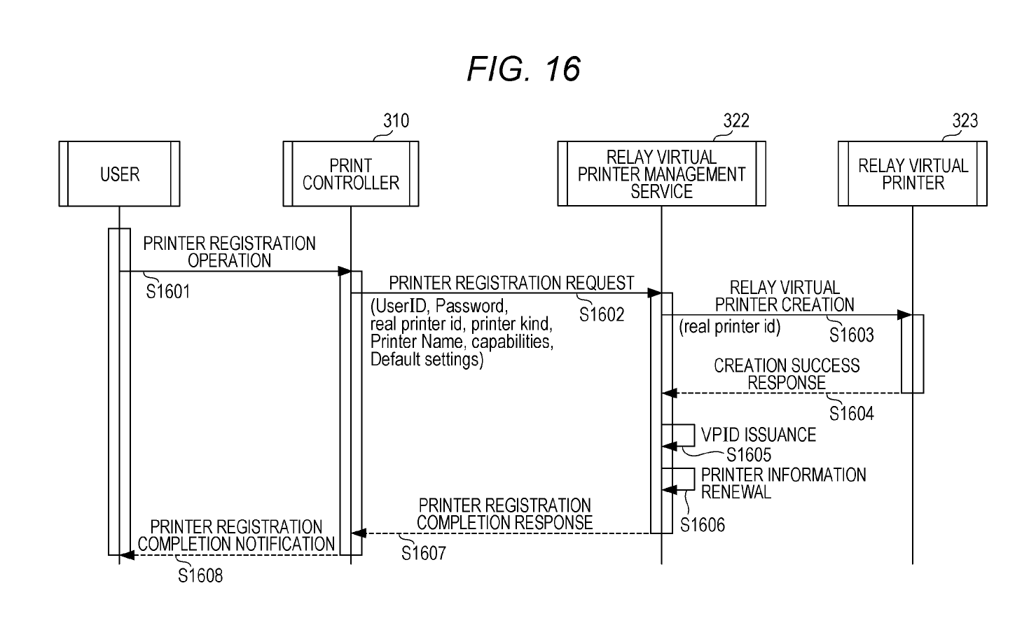

Hereinafter, the pre-registration processing, the main registration, and the print processing will be described with reference to FIGS. 16, 17, and 18, respectively.

First, processing in which the administrator registers the printer 110 to the print relay server 120, and the relay virtual printer 323 is realized within the print relay server 120 will be described with reference to FIG. 16.

In S1601, the administrator performs a registration operation to the relay virtual printer management service 322 through a UI of the printer 110. In S1602, the print controller 310 of the printer 110 requests registration of the printer 110 to the relay virtual printer management service 322. In S1603, the relay virtual printer management service 322 realizes the relay virtual printer 323 based on registration information. In S1604, the relay virtual printer 323 transmits a response of success of creation to the relay virtual printer management service 322. In S1605, the relay virtual printer management service 322 issues a VPID for identifying the created relay virtual printer 323. In S1606, the relay virtual printer management service 322 stores the VPID and information associated therewith as printer information. This corresponds to a table illustrated in FIG. 12A, and the VPID is managed in association with a RPID, a name, a capability thereof, and the like. In S1607, the relay virtual printer management service 322 notifies the print controller 310 of completion of the registration of the printer 110. In S1608, the print controller 310 outputs an instruction to the UI of the printer 110 to display the completion of the registration of the printer 110.

The first pre-registration processing has been described above.

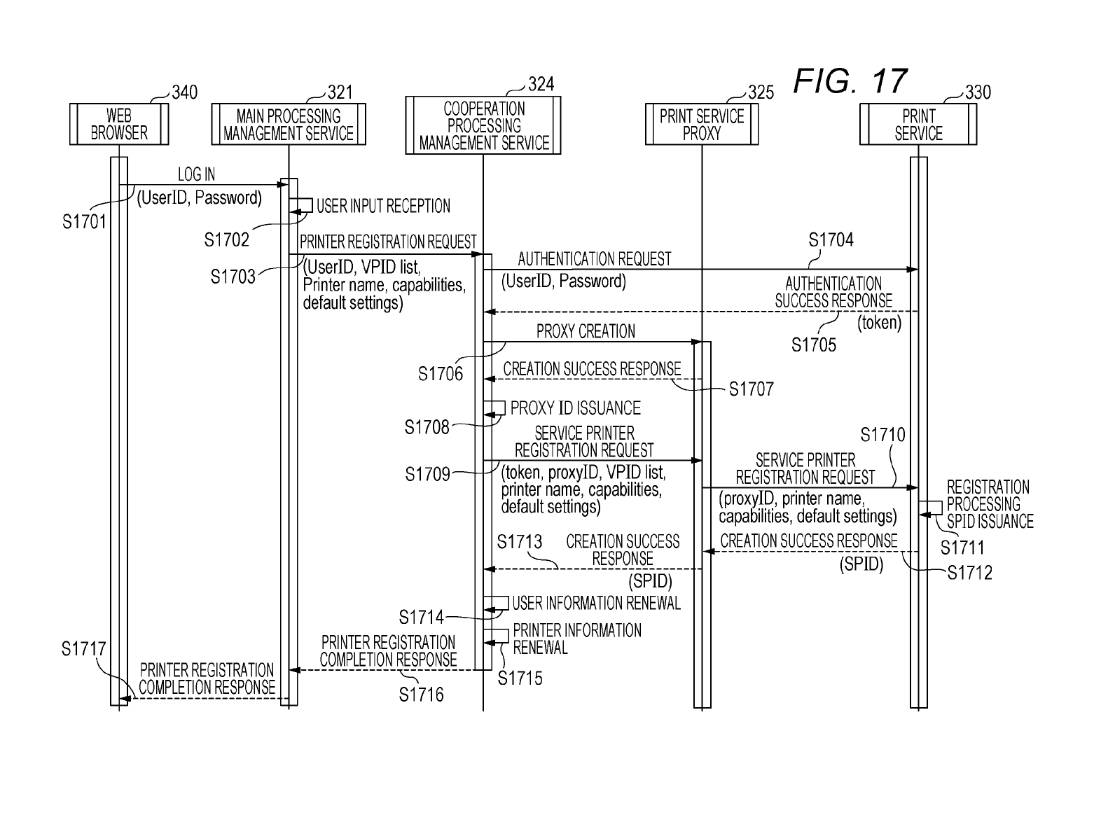

Next, second, processing in which the user registers the relay virtual printer 323 managed by the print relay server 120 to the print service 330 through the print service proxy 325 will be described with reference to FIG. 17.

In S1701, the user logs in to the print relay server 120 via the Web browser 340. In S1702, the main processing management service 321 of the print relay server 120 receives an operation by the user through a created UI, and receives a request of registration to the print service 330 of a dedicated service printer corresponding to the relay virtual printer 323. In S1703, the main processing management service 321 transmits the request for registering the printer 110 to the print service 330 and printer information to the cooperation processing management service 324.

In S1704, the cooperation processing management service 324 performs user authentication to the print service 330. Here, the user inputs a user account (an ID or a password) for accessing the print service 330 on a login screen displayed by the print service 330. In S1705, the print service 330 returns an authentication success response and an authentication token when the user authentication succeeds. The returned authentication token is received by the cooperation processing management service 324. Hereinafter, the authentication token is available for communicating with the print service 330. In the present embodiment, the token is used when the print service proxy 325 communicates with the print service 330. Although the authentication token is received by the print service proxy 325, the token may be managed in FIG. 12C. In S1706, the cooperation processing management service 324 realizes the print service proxy 325 for the present user account. In S1707, the print service proxy 325 transmits a creation success response to the cooperation processing management service 324. In S1708, the cooperation processing management service 324 issues a proxy ID for identifying the created print service proxy 325. In S1709, the cooperation processing management service 324 transmits, to the print service proxy 325, the authentication token to the print service 330, and a registration request and printer information of a dedicated service printer of the printer 110. In S1710, the print service proxy 325 performs connection with the print service 330 using the above-described authentication token, and next transmits a request of registration of the dedicated service printer of the relay virtual printer 323 and the printer information to the print service 330. In S1711, the print service 330 registers the relay virtual printer 323 corresponding to the printer 110, the registration request of which has been given, as the dedicated service printer, and issues an SPID for individual identification to the dedicated service printer. At that time, the print service 330 creates a table of FIG. 12E. In S1712, the print service 330 replies to the print service proxy 325 with a creation success response and the SPID. In S1713, the print service proxy 325 replies to the cooperation processing management service 324 with the creation success response and the SPID. In S1714, the cooperation processing management service 324 stores the user ID and information such as the proxy ID associated therewith as user information. This corresponds to the table illustrated in FIG. 12C. In S1715, the cooperation processing management service 324 stores the SPID and information such as the VPID associated therewith as printer information. This corresponds to the table illustrated in FIG. 12D. In S1716, the cooperation processing management service 324 notifies the main processing management service 321 of completion of the registration of the printer 110. In S1717, the main processing management service 321 displays the completion of the registration of the printer 110 on the Web browser 340.

The main registration has been described above.

As described above, the print service proxy 325 is generated for each user account of the user and for each print service, and the user can register a printer available to the user through the print service proxy 325.

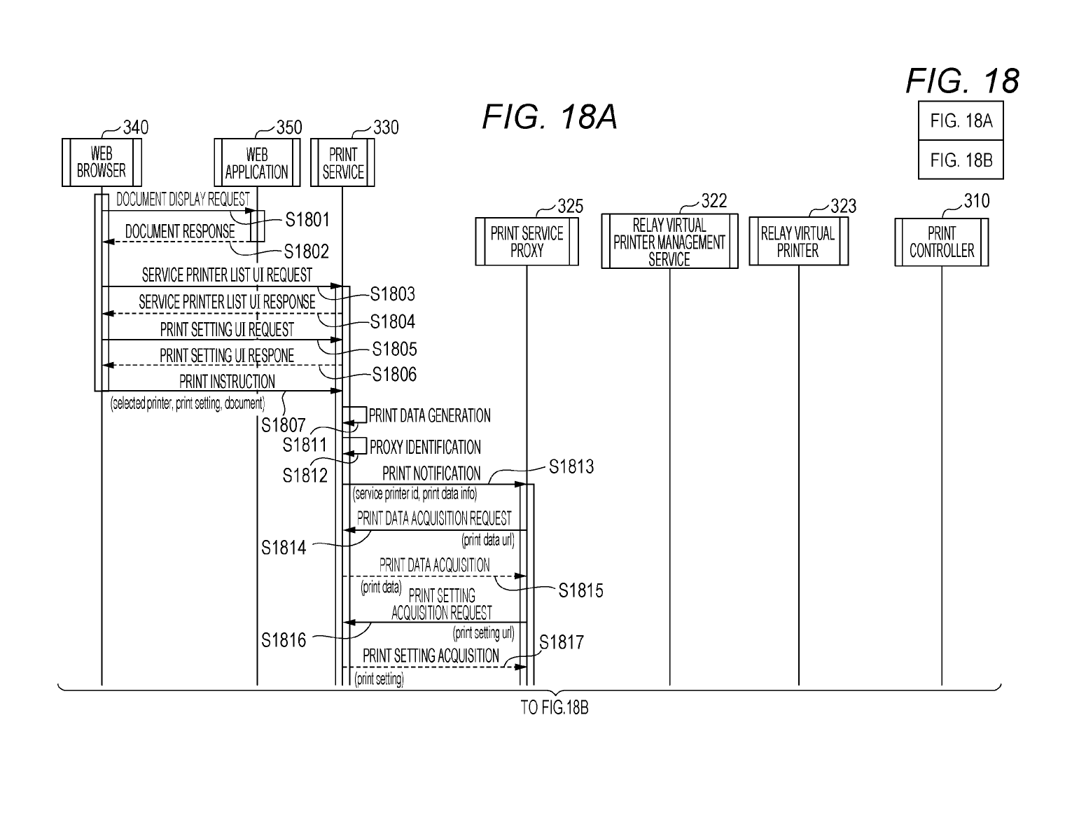

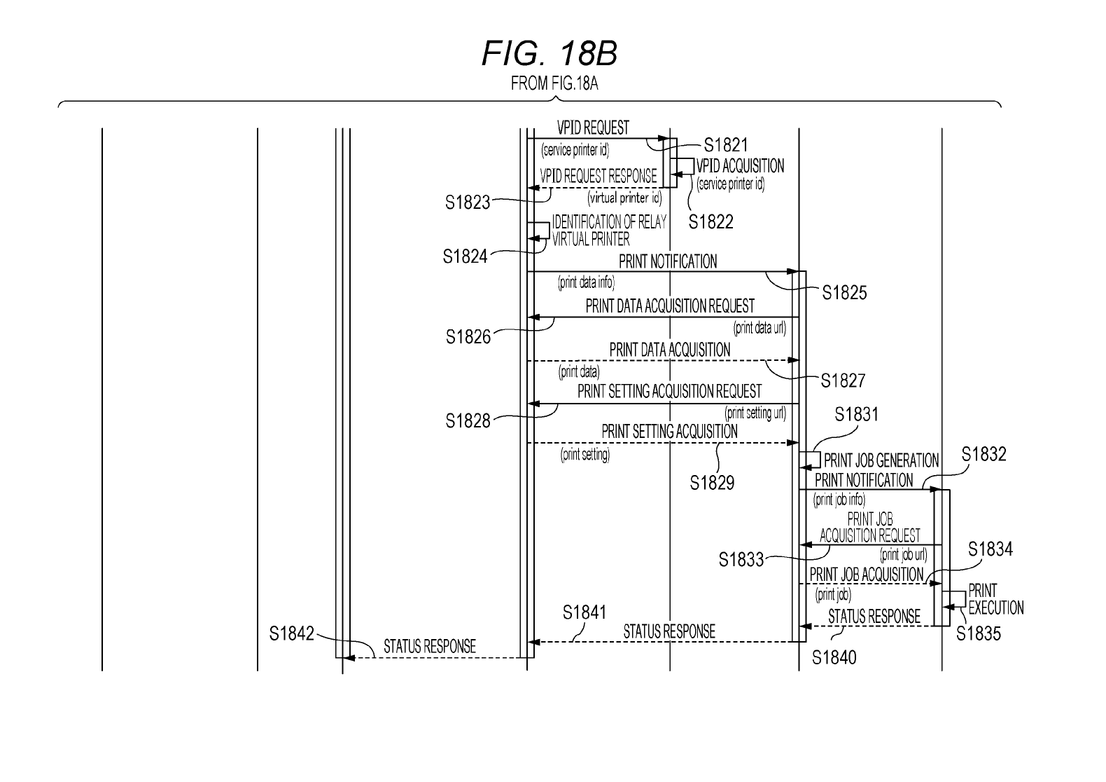

Finally, the third processing in which the user prints print data generated by the print server group 130 using the printer 110 through the print relay server 120 will be described with reference to FIG. 18 (FIG. 18A-18B).

In S1801, the Web browser 340 requests display of content that the user wants to edit to the Web application 350. In S1802, the Web application 350 transmits a screen of content corresponding to the requested content to the Web browser 340. In S1803, the Web browser 340 requests a list window of service printers registered in the print service 330 in response to an instruction of printing by the user through the content screen. In S1804, the print service 330 provides the Web browser 340 with a list window of dedicated service printers registered in the print service 330 and corresponding to the user who has made a request. The list window of dedicated service printers can be created by referring to the table of FIG. 12E and by acquiring a printer name list associated with an appropriate user ID. In S1805, in response to selection of a dedicated service printer by the user through the list window, the Web browser 340 requests a print setting screen corresponding to the selected dedicated service printer. The print service 330 receives the selection of the dedicated service printer and the request of a print setting screen from the Web browser 340. In S1806, the print service 330 provides the Web browser 340 with the print setting screen of the dedicated service printer. When the administrator renews the capability information of the dedicated service printer and registers the capability information to the print relay server, the print relay server 120 registers the renewed capability information to the printer information storage unit 1002 of the print service 330. Then, the print service 330 transmits the print setting screen to the Web browser 340 based on the renewed information of the printer information storage unit 1002. In S1807, the Web browser 340 transmits print setting input by the user through the print setting screen to the print service 330. The print service 330 receives the print setting input (designated) by the user from the Web browser 340.

In S1811, the print service 330 acquires, from the Web application 350, identification information of print data, printing of which has been instructed by the user. Further, the print service 330 acquires or generates the print data, and prepares a downloadable condition. In S1812, the print service 330 refers to FIG. 12E, and identifies an SPID associated with the designated printer name and the print service proxy 325. In S1813, the print service 330 transmits an SPID (identification information) of the dedicated service printer selected in S1805 to the identified print service proxy 325. By transmitting the SPID, generation of the print data for the dedicated service printer designated by the SPID is notified. In S1814, the print service proxy 325 requests acquisition of the print data to the print service 330. In S1815, the print service 330 transmits the print data to the print service proxy 325 in response to the acquisition request. The print service proxy 325 acquires the print data from the print service 330. In S1816, the print service proxy 325 requests acquisition of print setting to the print service 330. In S1817, the print service 330 transmits the print setting input in S1807 to the print service proxy 325. The print service proxy 325 acquires the print setting from the print service 330.

In S1821, the print service proxy 325 inquires of the relay virtual printer management service 322 about a VPID value corresponding to the SPID. In S1822, the relay virtual printer management service 322 refers to FIG. 12D, acquires a VPID corresponding to the designated SPID, and replies to the print service proxy 325 with the VPID value. In S1823, the print service proxy 325 identifies a process of the relay virtual printer 323 identified with the acquired VPID. In S1824, the print service proxy 325 notifies the relay virtual printer 323 of generation of the print data. In S1825, the relay virtual printer 323 request acquisition of the print data to the print service proxy 325. In S1826, the relay virtual printer 323 acquires the print data from the print service proxy 325. In S1827, the relay virtual printer 323 requests acquisition of print setting to the print service proxy 325. In S1828, the relay virtual printer 323 acquires the print setting from the print service proxy 325.

In S1831, the relay virtual printer 323 generates a print job (PDL data or a raster image) from the acquired print data based on the acquired print setting. In S1832, the relay virtual printer 323 notifies the print controller 310 of the corresponding printer 110 of generation of the print job. Here, the corresponding printer 110, that is, an actual printer that is identifiable by an RPID associated with the relay virtual printer 323 that is identifiable by the VPID can be acquired from a table of FIG. 12A. Note that, like the present embodiment, in realizing the relay virtual printer 323, the relay virtual printer 323 may have connection relation with the corresponding printer 110. In S1833, the print controller 310 requests acquisition of the print job to the relay virtual printer 323. In S1834, the relay virtual printer 323 transfers the print data to the print controller 310. The print controller 310 acquires the print job from the relay virtual printer 323. In S1835, the print controller 310 instructs a print unit to output the acquired print job.

In S1840, the print controller 310 transmits a status of a result of print execution to the relay virtual printer 323. In S1841, the relay virtual printer 323 transmits the status of a result of print execution to the print service proxy 325. In S1842, the print service proxy 325 transmits the status of a result of print execution to the print service 330.

The third print processing has been described above.

As described above, when a print instruction is given from the Web browser 340, a print notification is notified to the print service proxy 325. The print service proxy 325 identifies a VPID corresponding to the designated SPID, identifies a RPID corresponding to the VPID, and transmits print data to the printer 110 corresponding to the RPID, so that the print data is printed in the printer 110. Further, since the print service proxy 325 exists for each print service 330 and for each user ID, push printing from any print service of any user becomes possible on a steady basis.

Next, addition/deletion of a printer will be described.

A case will be described, in which a request of addition/deletion of a printer is given by the user in S1703 of FIG. 17. Since the user has already logged in to the print service 330, S1704 to S1705 are skipped. Further, since the print service proxy 325 has already been generated, S1706 to S1708 are skipped.

In S1709, the relay virtual printer 323 transmits a request of addition/deletion and information of a target printer 110 to the print service proxy 325.

In S1710, the print service proxy 325 transmits the request of addition/deletion and the information of the target printer to the print service 330. In S1711, the print service 330 performs addition or deletion of a dedicated service printer in accordance with the request of addition.

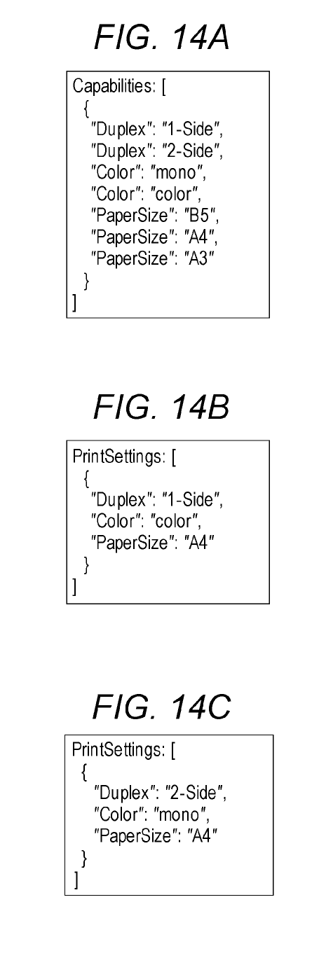

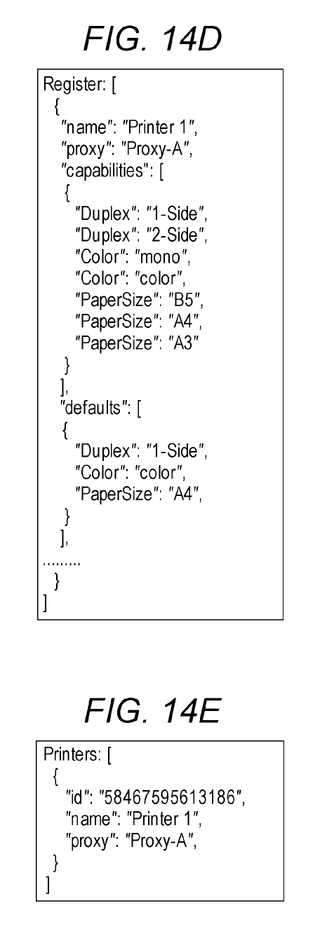

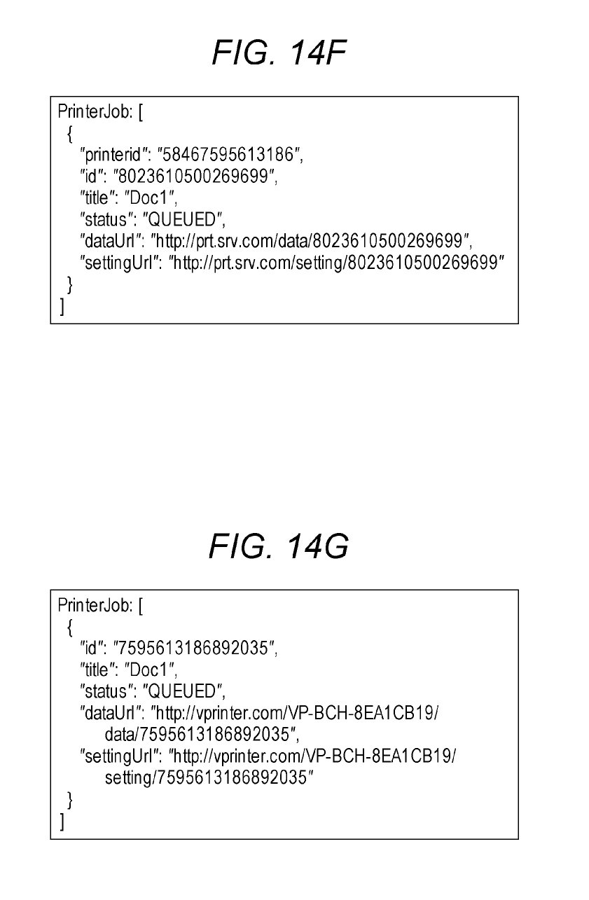

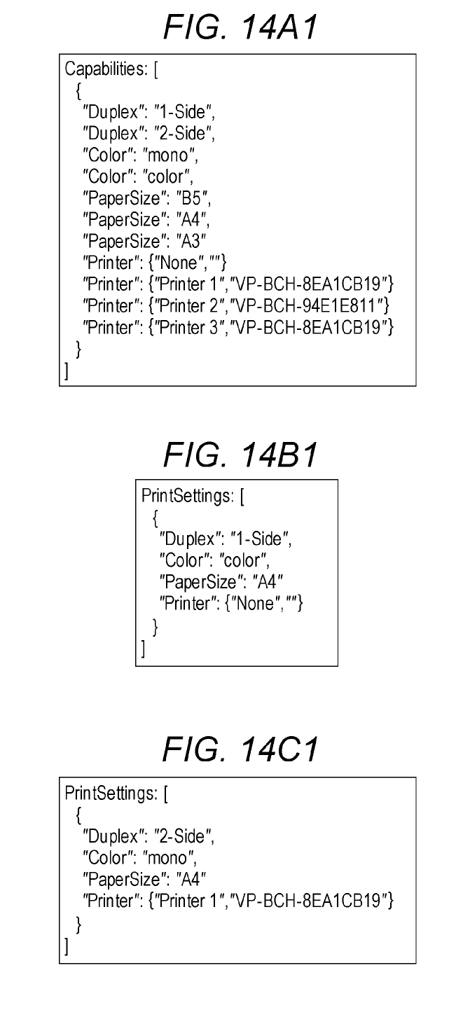

Note that, in the present embodiment, the format of information communicated within the content print system 1000 has been expressed in an XML format as illustrated in FIGS. 13A to 13C1. However, other format may be employed. For example, the information may be expressed in a JSON format as illustrated in FIGS. 14A to 14C1. FIG. 14A is a diagram illustrating the capabilities, FIG. 14B is a diagram illustrating the print setting initial value, FIG. 14C is a diagram illustrating print setting, FIG. 14D is a diagram illustrating the printer registration request, FIG. 14E is a diagram illustrating a reply to the printer registration request, FIG. 14F is a diagram illustrating the notification information A, and FIG. 14G is a diagram illustrating the notification information B.

Description of the first half part of Embodiment 1 has been done. In the following latter half part, a developing embodiment that has developed the basic embodiment described in the first half part will be described.

The basic embodiment described in the first half includes three types of processing: 1. pre-registration, 2. main registration, and 3. printing, and the user registers the relay virtual printer 323 to the print service 330 before execution of the printing. In the developing embodiment of the present disclosure, a main registration by the user before execution of printing is not necessary.

For example, consider a case where the user has noticed for the first time that a desired printer has not been registered to a print service only at the stage of selecting a printer of an output destination in order to print created print data. At this time, the user closes a screen illustrated in FIG. 11E to display a screen illustrated in FIG. 11B, and presses an addition/deletion button 1113 of a printer to display FIG. 11D. Then, after the user registers the desired printer on the screen illustrated in FIG. 11D, a work of displaying the screen illustrated in FIG. 11E again and selecting the printer, and executing printing is necessary. Further, when the administrator adds a new printer and the user wants to use the added printer, it is necessary for the user to perform a main registration similar to the basic embodiment, and then execute printing. Therefore, the developing embodiment to be described below will show that the user can easily perform a print output with a desired printer by omitting the main registration performed by the user even if registration of a printer is forgotten or the administrator adds a new printer.

First, an outline of the developing embodiment will be shown.

In the developing embodiment of the present disclosure, the user causes a general-purpose service printer, which is an output destination selectable from a Web application 350, to be an output destination of print data, whereby the print data can be printed by relaying a print relay server 120 using an arbitrary printer.

In a developed function, a print service 330 includes a general-purpose service printer that is a general-purpose output destination. The general-purpose service printer refers to a general-purpose printer object (general-purpose printer object) that integrates a plurality of printers including a printer 110 from among printer objects that identifies a printer on a print service. Only one general-purpose service printer is registered to the print service 330 by the user when the user uses a content print system 1000 for the first time. Also, the administrator performs pre-registration processing similar to the basic embodiment, and a relay virtual printer related to a printer is registered to the print relay server 120.

A list of printers available to the user is displayed as one of print setting items of the general-purpose service printer. The user can perform printing in an arbitrary printer by selecting the printer as one of the print setting items.

Since, in the basic embodiment, a dedicated service printer is registered for each relay virtual printer, the user transmits print data to the printer 110 by selecting the dedicated service printer corresponding to the printer 110 through a printer selection screen. However, since, in a developed constructive function, a dedicated service printer is not registered in advance, only the general-purpose service printer (universal printer) is displayed on a list of printers available for the user displayed on a printer selection screen. Therefore, the print data can be printed using the printer 110 by selecting the general-purpose service printer as an output destination on the printer selection screen and selecting the printer 110 from an item 1935 of printers, which is one of the print setting items.

The outline of the developing embodiment has been described above.

First, an initial state of the content print system 1000 to which the developing embodiment is applied will be described.

In a case where the developing embodiment is applied, an initial state of information managed by a user information storage unit 703 of a main processing management service 321 is illustrated in FIGS. 12B1 and 12C1. FIGS. 12B1 and 12C1 correspond to the information of FIGS. 12B and 12C in the basic embodiment, respectively. As illustrated in FIGS. 12B1 and 12C1, the relay virtual printer is pre-registered in advance for each user by the administrator.

Further, an initial state of information managed by a printer information storage unit 804 of a cooperation processing management service 324 is illustrated in FIG. 12D1. FIG. 12D1 corresponds to the information of FIG. 12D in the basic embodiment. As illustrated in FIG. 12D1, in the developing embodiment, a general-purpose service printer having a printer name of “Universal Printer” is registered in advance to the cooperation processing management service 324 for each user. The VPID, the capabilities, the print setting prescribed value of FIG. 12D1 will be described below.

Further, an initial state of information managed by a printer information storage unit 1002 of the print service 330 is illustrated in FIG. 12E1. FIG. 12E1 corresponds to the information of FIG. 12E in the basic embodiment. FIG. 12E1 illustrates, similar to FIG. 12D1, that a general-purpose service printer having a printer name of “Universal Printer” is registered to a print service in advance for each user.

The initial states have been described above.

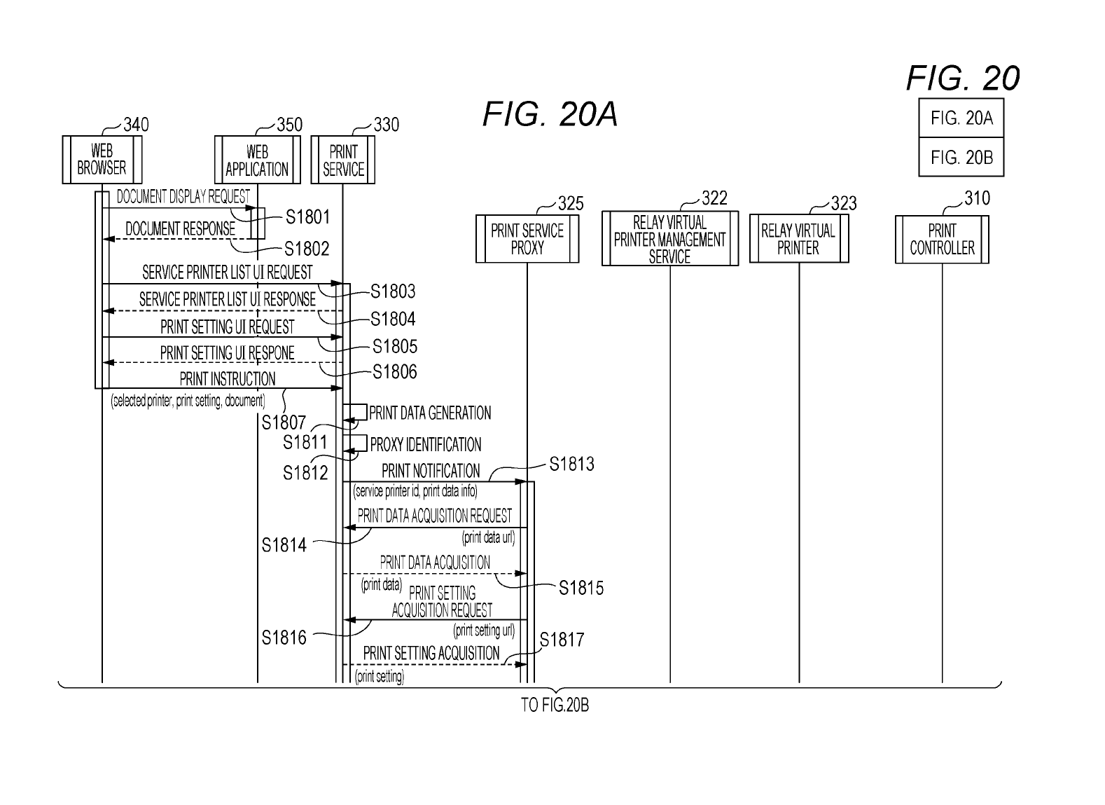

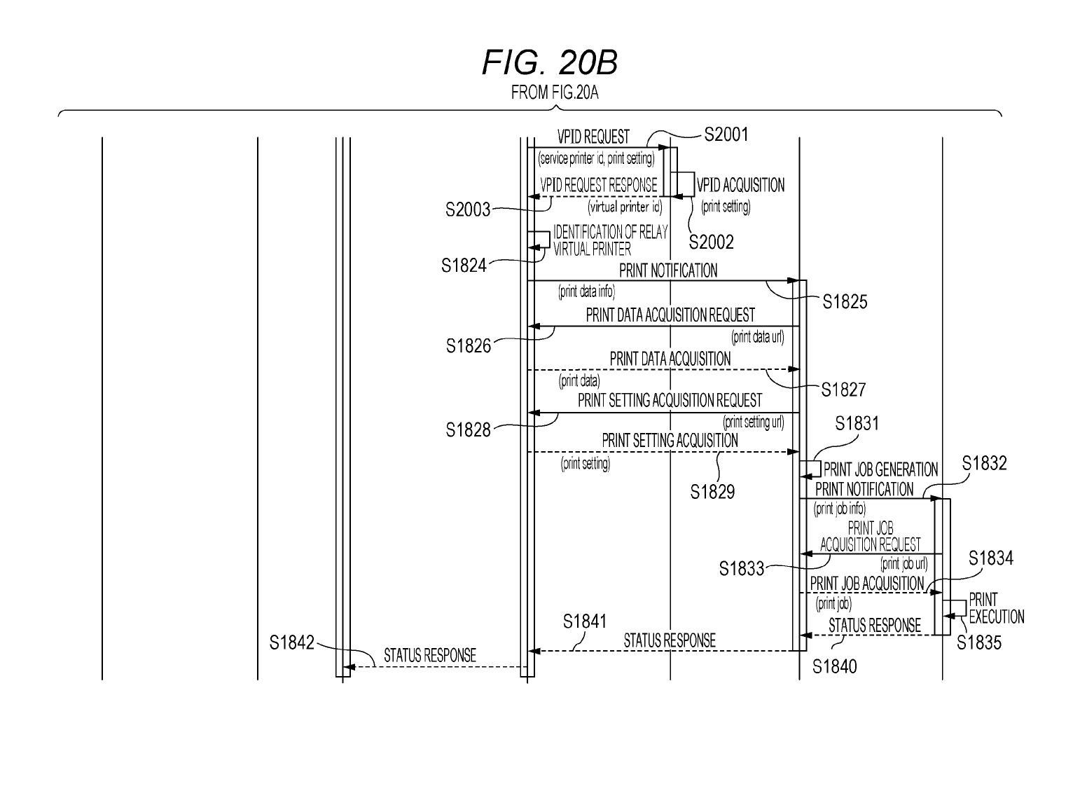

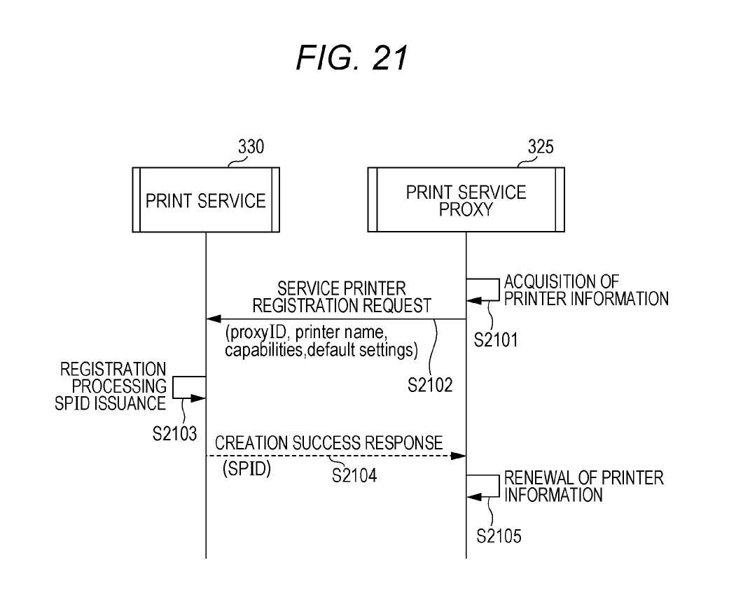

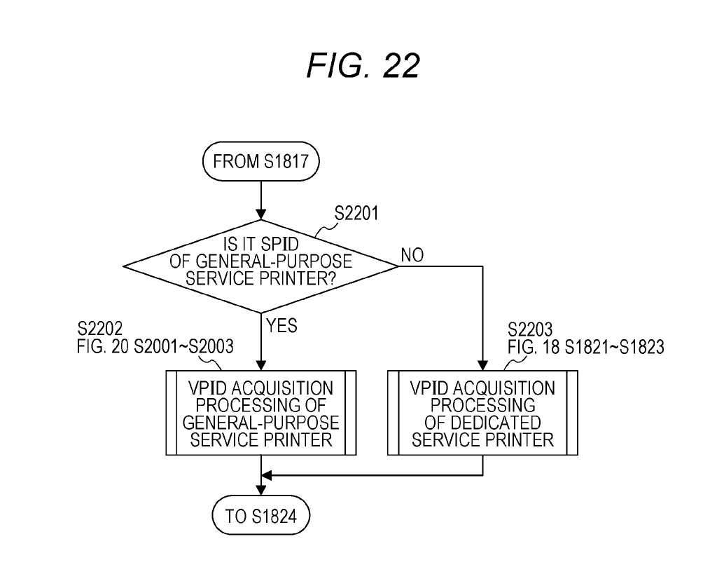

Next, print processing in the developing embodiment will be described with reference to a sequence diagram of FIG. 20 (FIG. 20A-20B). The user who uses the developing embodiment can perform printing in a desired printer from the initial state without performing the pre-registration processing of a relay virtual printer. Also, when the administrator adds a printer 110, the user can perform printing in the printer 110 without registering a relay virtual printer 323 corresponding to the added printer 110 to the print service 330.

As illustrated in FIG. 20 (FIG. 20A-20B), many steps in the print processing in the developing embodiment are configured from common steps to the print processing in the basic embodiment illustrated in FIG. 18 (FIG. 18A-18B). Therefore, hereinafter, processing and a data structure unique to the developing embodiment will be mainly described. Most of the printing processing in the developing embodiment and in the basic embodiment is configured from common steps. Therefore, the common steps in FIG. 20 (FIG. 20A-20B) are denoted with the same reference numbers as those in FIG. 18 (FIG. 18A-18B).

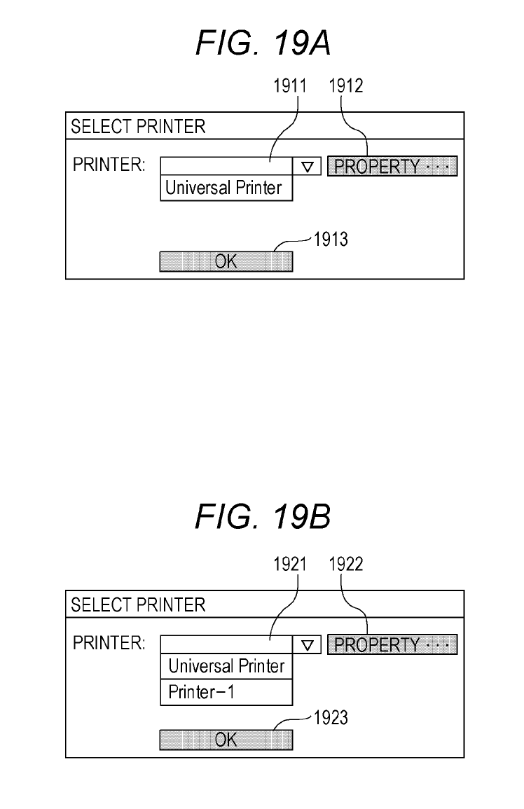

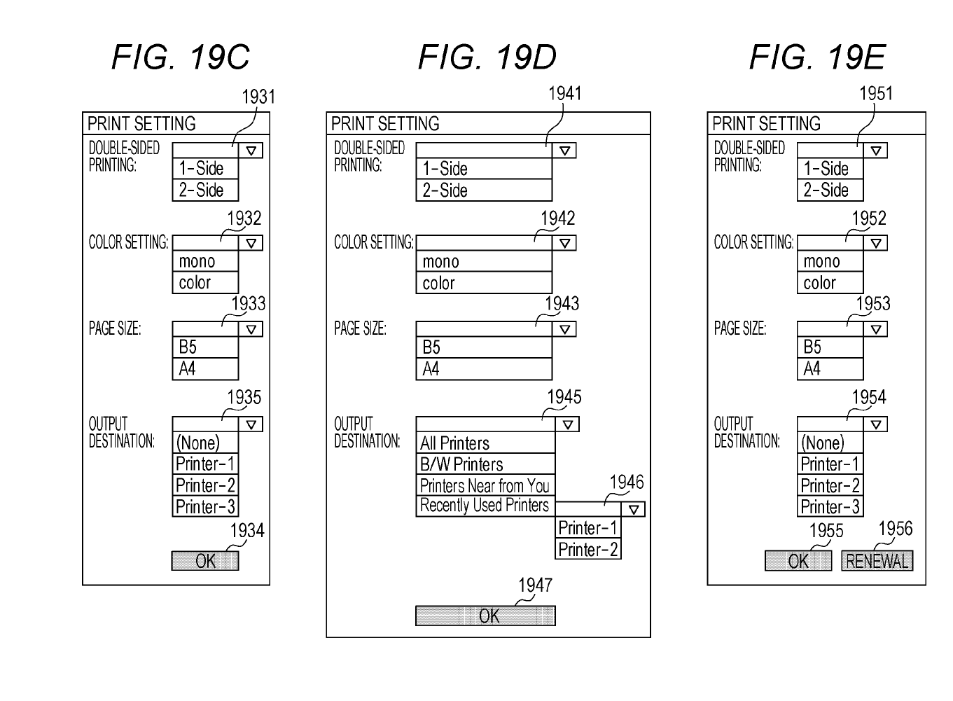

First, the processing from S1801 to S1817 is common to the basic embodiment. Note that a list window of service printers displayed on the Web browser 340 in S1804 in the initial state is the screen illustrated in FIG. 19A in the initial state of the constructive function. The list window of service printers is provided by the print service 330 to a Web browser 340. In the basic embodiment, the printer selection screen illustrated in FIG. 11E is displayed. However, since, in the initial state of the developing embodiment, the pre-registration processing is not performed, only the general-purpose service printer (universal printer) is displayed on an item 1911 of printers on the printer selection screen as illustrated in FIG. 19A. The reason why only the general-purpose service printer is displayed is that, in the initial state of the developing embodiment, referring to a table of FIG. 12E1, only a printer name of the general-purpose service printer is associated with an appropriate user ID.

In S1805, when the user selects the general-purpose service printer from the item 1911 of printers, and presses a property button 1912, the Web browser 340 requests a print setting screen of the selected general-purpose service printer. The print service 330 receives the selection of the general-purpose service printer and the request of the print setting screen from the Web browser 340.

In S1806, the print service 330 provides the Web browser 340 with the print setting screen of the general-purpose service printer. The print setting screen of the general-purpose service printer displayed on the Web browser 340 is different from the print setting screen of the dedicated service printer. The print setting screen of the general-purpose service printer is illustrated in FIG. 19C. The print setting screen of the general-purpose service printer has items similar to the print setting screen in the basic embodiment illustrated in FIG. 11C, and, further, has an item 1935 named “Printers”. A list of printers available for the users is displayed on the item 1935. When selecting a printer and pressing an OK button 1934, the user can perform printing in the selected printer without performing pre-registration processing.

As an example, on the item 1935 of printers in FIG. 19C, printers such as “Printer 1”, “Printer 2”, and “Printer 3” are selectable. Further, a value named “(None)” that indicates no printer is appropriate is also selectable, and a prescribed value of the item 1935 of printers in the initial state is “(None)”. When printing is performed under the condition that (None) is set, a print job is cancelled by processing described below. Since, in the developing embodiment, the user has not performed main registration of the relay virtual printer 323, print data happens to be transmitted to a printer that the user does not know. Therefore, such processing is performed. Note that other means to prevent an output from a printer that the user does not know can be considered, other than the means to cancel the print job when (None) is selected. For example, a means to change over to a print mode by pull printing when (None) is selected, or a user interface for a print instruction is formed to be a wizard format so that printer information of an output designation as the print setting is always input by the user.

The reason why the print setting screen when the general-purpose service printer is selected is different from the print setting screen when the dedicated service printer is selected is that the information of capabilities associated with the general-purpose service printer is different. The information of the general-purpose service printer is illustrated in FIGS. 13A1, 13B1, and 13C1. FIG. 13A1 illustrates the capabilities in an XML format, and each <Item> element in the drawing indicates the capability of the printer 110. Note that the capabilities may be expressed in a Json format like FIGS. 14A1, 14B1, and 14C1. FIG. 14A1 is a diagram illustrating the capabilities, FIG. 14B1 is a diagram illustrating the print setting initial value, and FIG. 14C1 is a diagram illustrating the print setting. When the capabilities of the developing embodiment is compared with that of the basic embodiment illustrated in FIG. 13A, information of <Printer> is added to the capabilities of the developing embodiment illustrated in FIG. 13A1. A value of a printer name is set to each <Item> element of <Printer>, and a VPID corresponding to the printer name is set to a VPID attribute. When the administrator adds and registers a new printer to the print relay server 120, the information of <Printer> of FIG. 13A1 is renewed, and a printer name and a VPID of the new printer are added. Further, when the user requests a print setting screen of the general-purpose service printer, the print service 330 transmits the print setting screen based on the renewed information.

FIG. 13B1 is a print setting initial value, and any one <Item> is selected from each of the print setting items. As illustrated in FIG. 13B1, single-sided output, color output, A4 size, and (None) as a printer of an output destination are set.

When the user changes the print setting on the print setting screen illustrated in FIG. 19C, the setting value becomes the state illustrated in FIG. 13C1. The example of FIG. 13C1 means that the both-sided output, the black-and-white output, the A4 size, and “Printer 1” as a printer of an output destination are set.

In S1807, when the user presses an OK button 1913 of FIG. 19A, the Web browser 340 transmits the print setting input by the user via the print setting screen to the print service 330. The print service 330 receives the print setting input (designated) by the user from the Web browser 340. Hereinafter, processing from S1811 to S1817 similar to the basic embodiment is performed.

In S2001, when S1817 is executed, a print service proxy 325 inquires of a relay virtual printer management service 322 about a VPID value corresponding to the SPID of the general-purpose virtual printer. Further, the print service proxy 325 transmits the SPID and the print setting acquired from the print service along with a VPID request to the relay virtual printer management service 322.

In S2002, the relay virtual printer management service 322 acquires the VPID.

In the basic embodiment, when the VPID is acquired, FIG. 12D is referred to, the VPID corresponding to the designated SPID is acquired, and a VPID value thereof is replied to the print service proxy 325. However, in the developing embodiment, as illustrated in FIG. 12D1, a VPID corresponding to the SPID has not been set. Therefore, even if information of FIG. 12D1 is referred to, the VPID corresponding to the SPID cannot be acquired.

This is because, in the developing embodiment, the VPID is not associated with the SPID of the general-purpose service printer one on one, and the VPID is associated with a printer name of a printer available to the user like FIG. 13A1.

Therefore, as a result of referring to FIG. 12D1, when there is no VPID corresponding to the SPID, the relay virtual printer management service 322 acquires a VPID from the information of the print setting received in S2001. The VPID can be acquired by referring to the VPID attribute in the information of <Item> elements of <Printer> illustrated in FIG. 13C1. Note that, when the value of the VPID attribute acquired from the information of <Item> elements of <Printer> is empty, this means that (None) is set as the output destination of the print setting. Therefore, the following processing is interrupted, and the print job is cancelled.

In S2003, the relay virtual printer management service 322 replies to the print service proxy 325 with the VPID acquired in S2002.

In S1824, the print service proxy 325 identifies the relay virtual printer 323 corresponding to the VPID acquired in S2003, and the following processing from S1825 to S1842 is the same as the basic embodiment. As a result of the processing from S1825 to S1842, the print job is transmitted to the printer 110 through the relay virtual printer 323, and a status of print completion is transmitted to the print service 330.

The print processing in the developing embodiment has been described above.

The developing embodiment of the present disclosure is based on the assumption that the pre-registration in the basic embodiment has been completed. If the number or the type of printers is changed due to purchase or replacing of printers, renewal of information thereof is performed by the administrator. When the administrator renews the information, processing similar to the pre-registration processing of the basic embodiment is performed. As a result of the pre-registration processing, the renewed information is, specifically, the information of FIGS. 12B1 and 12C1, the capability information of the general-purpose service printer illustrated in FIG. 12D1, and the information within <Item> elements of <Printer> of the capabilities illustrated in FIG. 13A1.

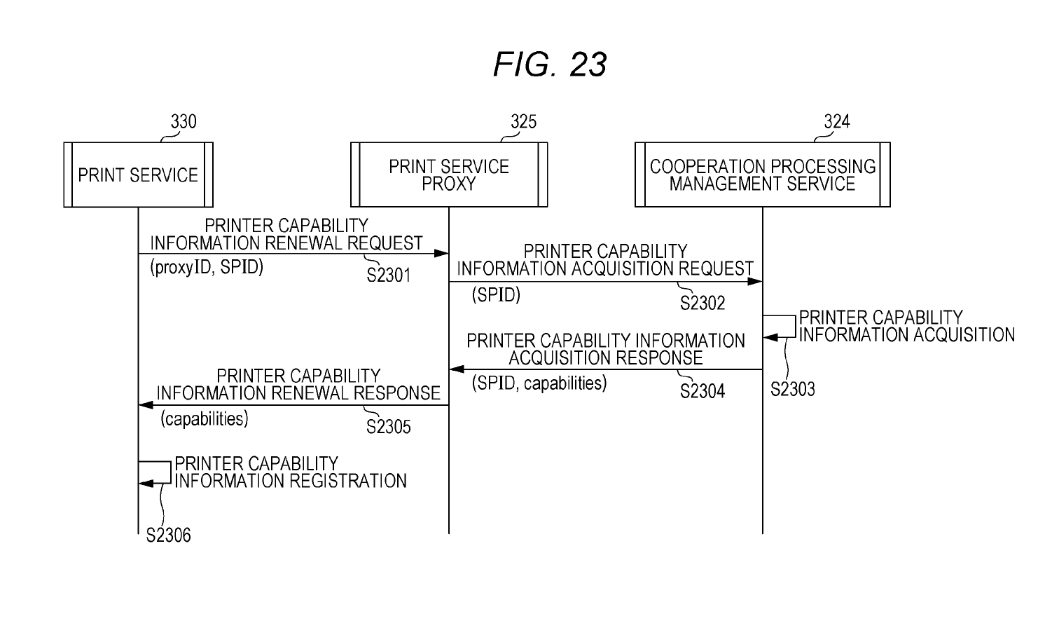

Here, when the capability information of the general-purpose service printer is renewed, a list of the output destination displayed on the print setting screen needs to be renewed. Specific processing for renewing the list of the output destination by the user will be described with reference to FIG. 23.

In S2301, the user presses a renewal button 1956 illustrated in FIG. 19E, and requests renewal of the general-purpose service printer capability information. When the user requests the renewal, the print service 330 transmits a proxy ID and an SPID of the general-purpose service printer along with a print setting item renewal request to the print service proxy 325. Here, the user renews the print setting item. However, the renewal may be automatically made when the user opens the printer selection screen illustrated in FIG. 19A or the print setting screen illustrated in FIG. 19E. Further, the print service 330 may request the renewal of the print setting item at given time intervals.

In S2302, the print service proxy 325 requests acquisition of the capability information of the general-purpose service printer to a cooperation processing management service 324. Further, the SPID is transmitted along with the acquisition request of the capability information of the general-purpose service printer.

In S2303, the cooperation processing management service 324 identifies the general-purpose service printer corresponding to the received SPID from the information illustrated in FIG. 12D1. Further, the capabilities (capability information) of the identified general-purpose service printer is acquired by referring to the information illustrated in FIG. 13A1.

In S2304, the cooperation processing management service 324 transmits the SPID of the general-purpose service printer and the acquired capability information of the general-purpose service printer to the print service proxy 325.

In S2305, the print service proxy 325 replies to the print service 330 with the acquired capability information of the printer.

In S2306, the print service 330 stores the received capability information in a printer information storage unit 1002, and completes registration of the capability information of the printer (capability registration unit).

The processing of renewing the print setting items has been described above.

The user can allow the print setting screen to display a list of the latest output destination by renewing the capability information of the general-purpose service printer registered in the print service 330.

### Embodiment 2

In Embodiment 2, after the print data is output to the printer 110 in the developing embodiment, a relay virtual printer 323 corresponding to the printer 110 is automatically registered to a print service 330 as a dedicated service printer.

The reason to perform such processing is that a printer that once outputs print data has a high possibility to be repeatedly selected as an output destination of print data. Note that the dedicated service printer does not necessarily have to be registered automatically. Therefore, a screen may be displayed so that the user can select whether he/she performs registration. Alternatively, the dedicated service printer may be selected in print setting of a general-purpose service printer.

Hereinafter, automatic registration processing of a dedicated service printer will be described with reference to a sequence diagram of FIG. 21.

First, in S2101, a print service proxy 325 acquires capability information of a printer 110 that has output print data. The capability information of the printer to be acquired is a printer name, capabilities, and a print setting initial value associated with the printer 110 that has executed printing and illustrated in FIG. 12A.

Next, in S2102, the print service proxy 325 transmits, to the print service 330, a registration request of a dedicated service printer corresponding to the printer 110 that has output the print data. At this time, the print service proxy 325 transmits a proxy ID, the printer name, the capabilities, and the print setting initial value along with the registration request.

Note that, in S2102, the dedicated service printer to be requested registration is managed in association with each user ID on the print service 330, similar to the general-purpose service printer. Therefore, the print service proxy 325 transmits a user account (an ID and a password) or an authentication token in transmitting the registration request.

Next, in S2103, the print service 330 performs registration processing of the dedicated service printer to the print service 330, and issues an SPID (an object registration unit). As a result of the registration processing, the capability information of the printer managed by the print service 330 makes a transition from FIG. 12E1 of an initial state to FIG. 12E2. Here, as an example, printing is executed in a “Printer 1”. From FIG. 12E2, it can be seen that a dedicated service printer corresponding to the “Printer 1” has been registered in addition to the general-purpose service printer.

When the registration of the dedicated service printer to the print service 330 has been completed, in S2104, the SPID issued in S2103 is transmitted from the print service 330 to the print service proxy 325 in addition to a dedicated service printer registration response.

Next, upon receiving the response of creation success of the dedicated service printer in step S2104, the print service proxy 325 renews printer information in step S1905. As a result of renewal processing of the printer information, the printer information managed by the print service proxy 325 makes a transition from FIG. 12D1 of an initial state to FIG. 12D2.

The processing from S2101 to S2104 is performed, and the SPID issued in S2103 and a VPID of the printer 110 that has performed printing are associated with each other, so that the automatic registration processing of a dedicated service printer is completed.

The automatic registration processing of a dedicated service printer in the developing embodiment has been described above.

Next, an example of a screen of a service printer list that has been changed as a result of the automatic registration processing will be illustrated in FIG. 19B. In a list box 1921 of FIG. 19B, the printer name “Printer 1” of the dedicated service printer that has been automatically registered is displayed in addition to the printer name “Universal Printer” of the general-purpose service printer. As a result of the automatic registration of the dedicated service printer, the “Printer 1” can be selected on a selection screen of a printer, not through the print setting.

In this way, the dedicated service printer is automatically registered to the print service in Embodiment 2. As a result, both the general-purpose service printer and the dedicated service printer are mixed as service printers registered in the print service.

However, according to the basic embodiment of Embodiment 1 and the developing embodiment, processing to be performed by a relay virtual printer management service 322 is changed depending on which of the dedicated service printer and the general-purpose service printer is selected by the user as an output destination of print data. That is, when the dedicated service printer is selected as the output destination, the print service proxy 325 transmits only the SPID to the relay virtual printer management service 322. Whereas, when the general-purpose service printer is selected as the output destination, the print service proxy 325 transmits the SPID and information of the print setting to the relay virtual printer management service 322.

Accordingly, in Embodiment 2, the print service proxy 325 performs determination as to whether the SPID received along with the print notification is of the dedicated service printer or of the general-purpose service printer after the processing of S1817. As a result of the determination, processing for acquiring a VPID is changed in the dedicated service printer and in the general-purpose service printer.

A function of the print service proxy 325 in Embodiment 2 will be described with reference to a sequence diagram of FIGS. 18 (FIG. 18A-18B) and 20 (FIG. 20A-20B), and a flowchart of FIG. 22.

In S2201 of FIG. 22, it is determined whether the SPID acquired from the print service 330 along with the print notification is of the general-purpose service printer or of the dedicated service printer. As a result, when the acquired SPID is an SPID of the general-purpose service printer, processing similar to S2001 to S2003 of FIG. 20B is performed in S2202. To be specific, the print service proxy 325 transmits the SPID and the information of the print setting to the print service 330 along with a VPID request, and the print service 330 acquires a VPID from the received information of the print setting, and responds to the print service proxy 325 with the VPID. Further, when the SPID acquired in S2201 is an SPID of the dedicated service printer, processing similar to S1821 to S1823 of FIG. 18B is performed in S2203. To be specific, the service proxy 325 transmits the SPID to the print service 330 along with a VPID request, and the print service 330 acquires a VPID corresponding to the SPID from the information illustrated in FIG. 12D, and responds to the print service proxy 325 with the VPID. When the processing of S2202 or of S2203 has been completed, identification of a relay virtual printer corresponding to the acquired VPID is performed in S1824 of FIGS. 18B and 20B. Following that, print processing similar to S1825 to S1842 is performed.

Note that it is configured such that the above-described automatic registration processing is skipped when the dedicated service printer corresponding to the printer 110 that has executed printing has already been registered to the print service 330.

When the automatic registration processing of a dedicated service printer is repeated, the number of dedicated service printers gradually increases, resulting in potential degradation of the workability of the user when a printer of an output destination is selected. Thus, when the number of dedicated service printers reaches a given number, the workability can be enhanced by automatically deleting a dedicated service printer corresponding to a printer having less print frequency. Alternatively, there is a method of automatically deleting a dedicated service printer corresponding to a printer that has not been used for a given period. Management of the print frequency can be easily realized by adding a new item to the table in FIG. 12D2, for example.

The management of a print frequency will be described with reference to FIG. 12D3. FIG. 12D3 illustrates management information in which a new item of a “printing number 1236” is added to the table of FIG. 12D2, and when print data is output to the “Printer 1”, and the dedicated service printer is registered.

As illustrated in FIG. 12D3, the print frequency 1236 of “Printer 1” is zero because it is initialized at the time of registering a dedicated service printer. Also, the print frequency 1236 of FIG. 12D3 indicates that printing has been performed ten times in a “Printer 2” as the output destination.

When the printing is executed having the “Printer 1” as the output destination, the print service proxy 325 increases the print frequency 1236 of the dedicated service printer of the “Printer 1” by one. The print service proxy 325 counts the number of the dedicated service printers registered to the print service 330 every time a new dedicated service printer is registered in S1905. As a result of the counting, if the number of the dedicated service printers registered to the print service 330 exceeds a given number (for example, 10), a deletion request of a service printer having a smallest print frequency 1236 is transmitted to the print service 330. If there is a plurality of service printers having the smallest print frequency 1236, one is randomly selected from among the plurality of service printers.

Difference of print setting between the general-purpose service printer and the dedicated service printer will be described. As described above, the print setting of the general-purpose service printer includes an item 1935 for selecting a printer of an output destination, which is not included in the print setting of the dedicated service printer. Other than the above, among items common to the dedicated service printer and the general-purpose service printer, restriction is given to some of the print setting of the general-purpose service printer. For example, three types of paper sizes: B5, A4, and A3 are selectable in a regular service printer. However, only two types of paper sizes: B5 and A4 are available for the general-purpose service printer, and A3 is not available. This is because it is difficult to reflect the capability information of the printer 110, which actually performs an output, in the print setting of the general-purpose service printer, which is a general-purpose output point. The reason why the item of color setting is the same is that even if the color setting is designated to a black-and-white printer, the setting can be automatically changed to the black-and-white setting. Also, the item of double-sided printing can be also automatically changed to the double-sided printing from single-sided printing similar to the color setting. Since the general-purpose service printer is a general-purpose output point where all registered printers are abstracted, it is difficult to avoid providing various restrictions for use of unique print setting although there is no problem if only the basic setting is set. Meanwhile, the print setting of the dedicated service printer can use all functions of the printer 110 because the dedicated service printer is a service printer that corresponds to the printer 110 one on one. Therefore, in Embodiment 2, after the dedicated service printer is registered, it becomes possible to perform setting in accordance with the capability of the printer 110 corresponding to the registered dedicated service printer.

### Embodiment 3

The number of printers is decreased with the configuration of the developed function of Embodiment 1. Therefore, identification on the printer selection screen of an output destination to be transmitted from the print service 330 to the Web browser 340 becomes easy. However, if the number of the relay virtual printers 323 registered to the print relay server 120 is large, the number of printers displayed on the item 1935 of printers of FIG. 19C becomes large, and therefore, it may be difficult for the user to identify a desired printer of an output destination.

Thus, display of the item 1935 of printers in a UI of the print setting may be changed so that the user can easily identify the output destination.

For example, as illustrated in FIG. 19D, in addition to the item of listing all printers, there is a method in which an item of listing only black-and-white printers, an item of listing printers close to a seat of the user, an item of listing recently used printers, and the like are displayed. For example, in FIG. 19D, as a result of selecting “Recently Used Printers” in the item 1945 with which a printer of an output destination is selected, recently used printers “Printer-1” and “Printer-2” are further displayed in an item 1946.

A printer is sorted out on the condition designated by the user, and the item 1946 in which only the sorted printer is listed is supplementary displayed in the item 1945 with which a printer is selected, whereby identification of a desired output destination by the user becomes easier.

### Other Embodiments

Embodiments of the present disclosure can also be realized by a computer of a system or apparatus that reads out and executes computer executable instructions recorded on a storage medium (e.g., computer-readable storage medium) to perform the functions of one or more of the above-described embodiment(s), and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-096561, filed Apr. 20, 2012, and Japanese Patent Application No. 2012-287238, filed Dec. 28, 2012, which are hereby incorporated by reference herein in their entirety.

What is claimed is:

1. A print system, comprising:
a print server; and
a print relay server configured to connect a plurality of image information apparatuses and the print server,
the print server including:
a providing unit configured to provide a selection screen for selecting a printer object and a print setting screen for designating print setting in response to a print instruction of content;
a reception unit configured to receive selection of the printer object and designation of the print setting via the selection screen and the print setting screen; and
a transmitting unit configured to transmit print data based on the content, and identification information of the printer object and the print setting received by the reception unit to the print relay server,
the print relay server including:
a receiving unit configured to receive the print data, the identification information of the printer object, and the print setting transmitted from the transmitting unit; and
a transferring unit configured to transfer the print data to an image formation apparatus designated as an output destination in the print setting received by the receiving unit when the identification information of the printer objet received by the receiving unit indicates a general-purpose printer object.

2. The print system according to claim 1, wherein the transferring unit transfers the print data to an image formation apparatus corresponding to the identification information of the printer object when the identification information of the printer object received by the receiving unit indicates a dedicated printer object.

3. The print system according to claim 1,
wherein the print relay server includes
a capability registration unit configured to register capability information of the printer object to the print server, and
the capability registration unit registers capability information including information of a plurality of image formation apparatuses as the output destination when registering capability information of the general-purpose printer object.

4. The print system according to claim 1, wherein the print relay server registers a dedicated printer object corresponding to the image formation apparatus that is the output destination of the print data as a printer object selectable on the selection screen after the print data is transferred by the transferring unit.

5. A print relay server configured to connect a print server configured to provide a client device with a screen and to receive an instruction via the screen, and a plurality of image formation apparatuses, the print relay server comprising:
a receiving unit configured to receive, from the print server, print data based on content, identification information of a printer object selected via a selection screen for selecting a printer object, and print setting designated via a print setting screen for designating print setting; and
a transferring unit configured to transfer the print data to an image formation apparatus designated as an output destination in the print setting received by the receiving unit when the identification information of the printer object received by the receiving unit indicates a general-purpose printer object.

6. The print relay server according to claim 5, wherein the transferring unit transfers the print data to an image formation apparatus corresponding to the identification information of the printer object when the identification information of the printer object received by the receiving unit indicates a dedicated printer object.

7. The print relay server according to claim 5, comprising:
a capability registration unit configured to register capability information of the printer object to the print server,
wherein the capability registration unit registers capability information including a plurality of image formation apparatuses as the output destination when registering capability information of the general-purpose printer object.

8. The print relay server according to claim 5, comprising:
an object registration unit configured to register a dedicated printer object corresponding to the image formation apparatus as the output destination of the print data as a printer object selectable on the selection screen after the print data is transferred by the transferring unit.

9. A client device configured to communicate with a print server, the client device comprising:
a first display control unit configured to receive a selection screen for selecting a printer object from the print server, and to display the selection screen in response to a print instruction of content; and
a second display control unit configured to receive a print setting screen for designating print setting from the print server, and to display the print setting screen,
wherein the second display control unit controls the print setting screen so that an image information apparatus to be an output destination of print data based on the content is designated on the print setting screen when a general-purpose printer object is selected on the selection screen displayed by the first display control unit.

10. The client device according to claim 9, wherein the second display control unit sorts out the printer object on a designated condition, and displays the sorted printer object on the print setting screen.

11. A method of controlling a print system including a print server and a print relay server configured to connect a plurality of image formation apparatuses and the print server, the method comprising:
providing a selection screen for selecting a printer object and a print setting screen for designating print setting in response to a print instruction of content;
receiving selection of a printer object and designation of print setting via the selection screen and the print setting screen;
transmitting, to the print relay server, print data based on the content, and identification information of the printer object and the print setting received by the receiving;
receiving the transmitted print data, the transmitted identification information of the printer object, and the transmitted print setting; and
transferring the print data to an image formation apparatus designated as an output destination in the received print setting when the received identification information of the printer object indicates a general-purpose printer object.

12. A method of controlling a print relay server configured to connect a print server providing a client device with a screen and receiving an instruction via the screen, and a plurality of image formation apparatuses, the method comprising:
receiving, from the print server, print data based on content, identification information of a printer object selected via a selection screen for selecting a printer object, and print setting designated via a print setting screen for designating print setting; and
transferring the print data to an image formation apparatus designated as an output destination in the received print setting when the received identification information of the printer object indicates a general-purpose printer object.

13. A method of controlling a client device configured to communicate with a print server, the method comprising:
receiving a selection screen for selecting a printer object from the print server and displaying the selection screen in response to a print instruction of content; and
receiving a print setting screen for designating print setting from the print server and displaying the print setting screen,
wherein, when a general-purpose printer object is selected on the displayed selection screen, controlling the print setting screen so that an image information apparatus to be an output destination of print data based on the content is designated on the print setting screen.

14. A computer-readable storage medium storing a program that causes a computer to execute the method of claim 13.
